(19) United States
(12) Patent Application Publication
(10) Pub. No.: US 2025/0306704 A1
(43) Pub. Date: Oct. 2, 2025

(54) ELECTRONIC DEVICE

(71) Applicant: Samsung Display Co., LTD., Yongin-si (KR)

(72) Inventors: GAYOUNG KIM, Yongin-si (KR); SANGHYUN LIM, Yongin-si (KR)

(21) Appl. No.: 19/050,992

(22) Filed: Feb. 11, 2025

(30) Foreign Application Priority Data
Mar. 26, 2024 (KR) 10-2024-0040744

(51) Int. Cl. G06F 3/041; G06F 3/0354; G06F 3/044; G06F 3/046

(52) U.S. Cl. CPC G06F 3/04166; G06F 3/04164; G06F 3/0446; G06F 3/046; G06F 3/03543; G06F 2203/04106; G06F 2203/04107; G06F 2203/04111; G06F 2203/04112

(57) ABSTRACT

An electronic device includes a sensor layer and a sensor driver including a plurality of amplifiers and an inverter. The sensor layer includes a plurality of first electrodes arranged in a first direction, a plurality of second electrodes that cross the plurality of first electrodes, a plurality of first trace lines electrically connected to the plurality of first electrodes in a one-to-one correspondence, and a plurality of second trace lines electrically connected to the plurality of second electrodes in a one-to-one correspondence. The plurality of amplifiers include a first amplifier including a first input terminal and a second input terminal. The first input terminal is electrically connected with a second-first electrode among the plurality of second electrodes, and the second input terminal is electrically connected with a second-second electrode among the plurality of second electrodes via the inverter.

### CROSS-REFERENCE TO RELATED APPLICATION

The present application claims priority to and the benefit of Korean Patent Application No. 10-2024-0040744, filed on Mar. 26, 2024, in the Korean Intellectual Property Office, the entire disclosure of which is incorporated herein by reference.

### BACKGROUND

Aspects of some embodiments of the present disclosure described herein relate to an electronic device for sensing an input by a pen.

Multimedia electronic devices, such as televisions, mobile phones, tablet computers, notebook computers, car navigation units, game machines, and the like, include a display device for displaying an image. The electronic devices may include a sensor layer (or, an input sensor) capable of providing a touch-based input method that enables a user to intuitively and conveniently input information or instructions in an easy and simple manner, in addition to a conventional input method such as a button, a keyboard, a mouse, or the like. The sensor layer may sense the user's touch or pressure. Meanwhile, pens for users accustomed to inputting information using writing instruments or pens for accurate touch inputs in specific application programs (e.g., application programs for sketching or drawing) have been increasingly demanded.

The above information disclosed in this Background section is only for enhancement of understanding of the background and therefore the information discussed in this Background section does not necessarily constitute prior art.

### SUMMARY

Aspects of some embodiments of the present disclosure include an electronic device for sensing an input by a pen.

According to some embodiments of the present disclosure, an electronic device includes a sensor layer in which a sensing area and a peripheral area adjacent to the sensing area are defined and a sensor driver that drives the sensor layer and includes a plurality of amplifiers and an inverter. According to some embodiments, the sensor layer includes a plurality of first electrodes in the sensing area and arranged in a first direction, a plurality of second electrodes that are in the sensing area and arranged in a second direction crossing the first direction and that cross the plurality of first electrodes, a plurality of first trace lines electrically connected to the plurality of first electrodes in a one-to-one correspondence, and a plurality of second trace lines electrically connected to the plurality of second electrodes in a one-to-one correspondence. According to some embodiments, the plurality of amplifiers include a first amplifier including a first input terminal and a second input terminal, the first input terminal is electrically connected with a second-first electrode among the plurality of second electrodes, and the second input terminal is electrically connected with a second-second electrode among the plurality of second electrodes via the inverter.

According to some embodiments, the plurality of second trace lines may include a plurality of second-first trace lines and a plurality of second-second trace lines spaced apart from each other with the sensing area therebetween.

According to some embodiments, one second-first trace line among the plurality of second-first trace lines may be electrically connected to the second-first electrode and the first input terminal, and one second-second trace line among the plurality of second-second trace lines may be electrically connected to the second-second electrode and the inverter.

According to some embodiments, the sensor driver may selectively operate in a first mode to sense a touch input or in a second mode to sense a pen input. According to some embodiments, the second mode may include a pen sensing driving mode. In the pen sensing driving mode, the first amplifier may receive a first reception signal based on an induced current flowing through the second-first electrode and a second reception signal based on an induced current flowing through the second-second electrode.

According to some embodiments, a signal output from the first amplifier in the pen sensing driving mode may be a signal in which signals by currents induced in the one second-first trace line and the one second-second trace line cancel each other out.

According to some embodiments, the plurality of amplifiers may further include a second amplifier including a third input terminal and a fourth input terminal and a third amplifier including a fifth input terminal and a sixth input terminal. According to some embodiments, the third input terminal and the fourth input terminal may be electrically connected to corresponding second-first trace lines among the plurality of second-first trace lines, respectively. According to some embodiments, the fifth input terminal and the sixth input terminal may be electrically connected to corresponding second-second trace lines among the plurality of second-second trace lines, respectively.

According to some embodiments, the second-first electrode may be electrically connected with the fourth input terminal of the second amplifier.

According to some embodiments, the second-second electrode may be electrically connected with the fifth input terminal of the third amplifier.

According to some embodiments, the first input terminal, the third input terminal, and the fifth input terminal may be inverting input terminals, and the second input terminal, the fourth input terminal, and the sixth input terminal may be non-inverting input terminals.

According to some embodiments, the electronic device may further include a plurality of pads electrically connected to the plurality of first trace lines and the plurality of second trace lines, and the plurality of pads may be arranged in the first direction.

According to some embodiments, the plurality of second trace lines may be longer than the plurality of first trace lines.

According to some embodiments, at least one second electrode among the plurality of second electrodes may be between the second-first electrode and the second-second electrode.

According to some embodiments, the second-first electrode and the second-second electrode may be adjacent to each other, and among the plurality of second electrodes, some of the remaining second electrodes and the other remaining second electrodes may be spaced apart from each other with the second-first electrode and the second-second electrode therebetween.

According to some embodiments of the present disclosure, an electronic device includes a sensor layer in which a sensing area and a peripheral area adjacent to the sensing area are defined and a sensor driver that drives the sensor layer and selectively operates in a first mode to sense a touch input or in a second mode to sense a pen input. According to some embodiments, the sensor layer includes a plurality of first electrodes in the sensing area and arranged in a first direction, a plurality of second electrodes that are in the sensing area and arranged in a second direction crossing the first direction and that cross the plurality of first electrodes, a plurality of first trace lines electrically connected to the plurality of first electrodes in a one-to-one correspondence, and a plurality of second trace lines electrically connected to the plurality of second electrodes in a one-to-one correspondence. According to some embodiments, portions of the plurality of second trace lines spaced apart from the sensing area in the first direction extend in the second direction. In the second mode, the sensor driver differentially senses signals received from the plurality of second electrodes and calculates a coordinate with respect to an axis parallel to the second direction based on a signal in which signals caused by the plurality of second trace lines cancel each other out.

According to some embodiments, the sensor driver may include a plurality of amplifiers and an inverter. According to some embodiments, the plurality of second trace lines may include a plurality of second-first trace lines and a plurality of second-second trace lines spaced apart from each other with the sensing area therebetween. According to some embodiments, the plurality of amplifiers may include a first amplifier including a first input terminal and a second input terminal, the first input terminal may be electrically connected with a second-first electrode among the plurality of second electrodes, and the second input terminal may be electrically connected with a second-second electrode among the plurality of second electrodes via the inverter. According to some embodiments, one second-first trace line among the plurality of second-first trace lines may be electrically connected to the second-first electrode and the first input terminal, and one second-second trace line among the plurality of second-second trace lines may be electrically connected to the second-second electrode and the inverter.

According to some embodiments, at least one second electrode among the plurality of second electrodes may be between the second-first electrode and the second-second electrode.

According to some embodiments, the second-first electrode and the second-second electrode may be adjacent to each other, and among the plurality of second electrodes, some of the remaining second electrodes and the other remaining second electrodes may be spaced apart from each other with the second-first electrode and the second-second electrode therebetween.

According to some embodiments, the plurality of amplifiers may further include a second amplifier including a third input terminal and a fourth input terminal and a third amplifier including a fifth input terminal and a sixth input terminal. According to some embodiments, the third input terminal and the fourth input terminal may be electrically connected to corresponding second-first trace lines among the plurality of second-first trace lines, respectively. According to some embodiments, the fifth input terminal and the sixth input terminal may be electrically connected to corresponding second-second trace lines among the plurality of second-second trace lines, respectively.

According to some embodiments of the present disclosure, an electronic device includes a sensor layer in which a sensing area and a peripheral area adjacent to the sensing area are defined and a sensor driver that drives the sensor layer and selectively operates in a first mode to sense a touch input or in a second mode to sense a pen input. According to some embodiments, the sensor layer includes a plurality of first electrodes in the sensing area and arranged in a first direction, a plurality of second electrodes that are in the sensing area and arranged in a second direction crossing the first direction and that cross the plurality of first electrodes, a plurality of first trace lines electrically connected to the plurality of first electrodes in a one-to-one correspondence, and a plurality of second trace lines electrically connected to the plurality of second electrodes in a one-to-one correspondence. According to some embodiments, the plurality of second trace lines include a plurality of second-first trace lines and a plurality of second-second trace lines spaced apart from each other with the sensing area therebetween. According to some embodiments, in the second mode, the sensor driver calculates a coordinate by differentially sensing signals received from one second-first trace line among the plurality of second-first trace lines and one second-second trace line among the plurality of second-second trace lines.

According to some embodiments, the sensor driver may include an amplifier including a first input terminal and a second input terminal and an inverter electrically connected to the second input terminal of the amplifier. According to some embodiments, the one second-first trace line may be electrically connected to the first input terminal, and the one second-second trace line may be electrically connected to the second input terminal via the inverter.

According to some embodiments, the second mode may include a pen sensing driving mode. In the pen sensing driving mode, the amplifier may receive a first reception signal based on an induced current flowing through a second-first electrode connected to the one second-first trace line among the plurality of second electrodes and a second reception signal based on an induced current flowing through a second-second electrode connected to the one second-second trace line among the plurality of second electrodes. According to some embodiments, a signal output from the amplifier may be a signal in which signals by currents induced in the one second-first trace line and the one second-second trace line cancel each other out.

### BRIEF DESCRIPTION OF THE DRAWINGS

The above and other aspects and features of some embodiments of the present disclosure will become more apparent by describing in more detail aspects of some embodiments thereof with reference to the accompanying drawings.

FIG. 1A is a perspective view of an electronic device according to some embodiments of the present disclosure.

FIG. 1B is a rear perspective view of the electronic device according to some embodiments of the present disclosure.

FIG. 2 is a perspective view of an electronic device according to some embodiments of the present disclosure.

FIG. 3 is a perspective view of an electronic device according to some embodiments of the present disclosure.

FIG. 4 is a schematic sectional view of a display panel according to some embodiments of the present disclosure.

FIG. 5 is a view for explaining an operation of an electronic device according to some embodiments of the present disclosure.

FIG. 6A is a sectional view of the display panel according to some embodiments of the present disclosure;

FIG. 6B is a sectional view of a sensor layer according to some embodiments of the present disclosure.

FIG. 7A is a plan view of the display panel according to some embodiments of the present disclosure.

FIG. 7B is a plan view of a display panel according to some embodiments of the present disclosure.

FIG. 8A is a plan view illustrating a first conductive layer of a sensing unit according to some embodiments of the present disclosure.

FIG. 8B is a plan view illustrating a second conductive layer of the sensing unit according to some embodiments of the present disclosure.

FIG. 9 is a sectional view of the sensor layer taken along line I-I′ illustrated in each of FIGS. 8A and 8B according to some embodiments of the present disclosure.

FIG. 10A is an enlarged plan view of area AA′ illustrated in FIG. 8A.

FIG. 10B is an enlarged plan view of area BB′ illustrated in FIG. 8B.

FIG. 11A is a view illustrating an operation of a sensor driver according to some embodiments of the present disclosure.

FIG. 11B is a view illustrating an operation of the sensor driver according to some embodiments of the present disclosure.

FIG. 12 is a view for explaining a first mode according to some embodiments of the present disclosure.

FIG. 13 is a view for explaining a second mode according to some embodiments of the present disclosure.

FIG. 14A is a graph depicting the waveform of a first signal according to some embodiments of the present disclosure.

FIG. 14B is a graph depicting the waveform of a second signal according to some embodiments of the present disclosure.

FIG. 15 is a view for explaining the second mode according to some embodiments of the present disclosure.

FIG. 16 is a view for explaining the second mode based on a sensing unit according to some embodiments of the present disclosure.

FIG. 17 is a view illustrating some components of the sensor layer and some components of the sensor driver according to some embodiments of the present disclosure.

FIG. 18 is a view illustrating some components of the sensor layer and some components of a sensor driver according to some embodiments of the present disclosure.

FIG. 19 is a view illustrating some components of the sensor layer and some components of a sensor driver according to some embodiments of the present disclosure.

FIG. 20 is a plan view of a display panel according to some embodiments of the present disclosure.

FIG. 21 is a view illustrating some components of a sensor layer and some components of a sensor driver according to some embodiments of the present disclosure.

FIG. 22 is a view illustrating some components of the sensor layer and some components of a sensor driver according to some embodiments of the present disclosure.

FIG. 23 is a view illustrating some components of the sensor layer and some components of a sensor driver according to some embodiments of the present disclosure.

### DETAILED DESCRIPTION

In this specification, when it is mentioned that a component (or, an area, a layer, a part, etc.) is referred to as being “on”, “connected to” or “coupled to” another component, this means that the component may be directly on, connected to, or coupled to the other component or a third component may be present therebetween.

Identical reference numerals refer to identical components. Additionally, in the drawings, the thicknesses, proportions, and dimensions of components are exaggerated for effective description. As used herein, the term “and/or” includes all of one or more combinations defined by related components.

Terms such as first, second, and the like may be used to describe various components, but the components should not be limited by the terms. The terms may be used only for distinguishing one component from other components. For example, without departing the scope of the present disclosure, a first component may be referred to as a second component, and similarly, the second component may also be referred to as the first component. The terms of a singular form may include plural forms unless otherwise specified.

In addition, terms such as “below”, “under”, “above”, and “over” are used to describe a relationship of components illustrated in the drawings. The terms are relative concepts and are described based on directions illustrated in the drawing.

It should be understood that terms such as “comprise”, “include”, and “have”, when used herein, specify the presence of stated features, numbers, steps, operations, components, parts, or combinations thereof, but do not preclude the presence or addition of one or more other features, numbers, steps, operations, components, parts, or combinations thereof.

Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

The terms “part” and “unit” mean a software component or a hardware component that performs a specific function. The hardware component may include, for example, a field-programmable gate array (FPGA) or an application-specific integrated circuit (ASIC). The software component may refer to executable code and/or data used by executable code in an addressable storage medium. Thus, software components may be, for example, object-oriented software components, class components, and working components, and may include processes, functions, properties, procedures, subroutines, program code segments, drivers, firmware, micro-codes, circuits, data, databases, data structures, tables, arrays or variables.

Hereinafter, aspects of some embodiments of the present disclosure will be described in more detail with reference to the accompanying drawings.

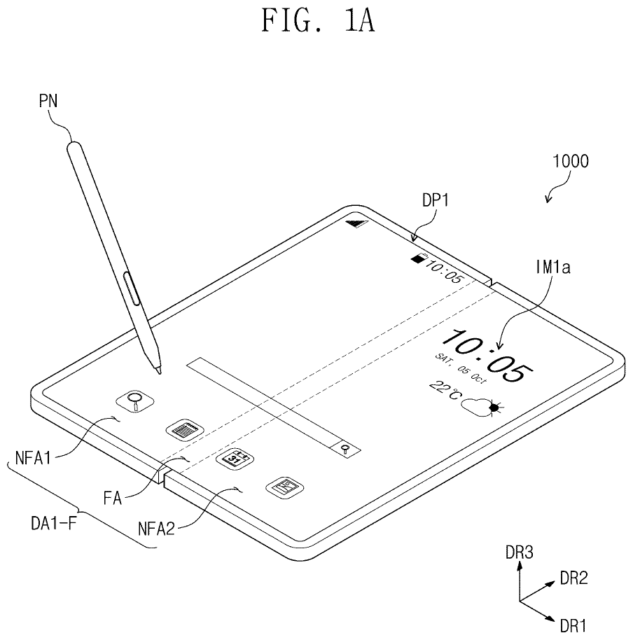

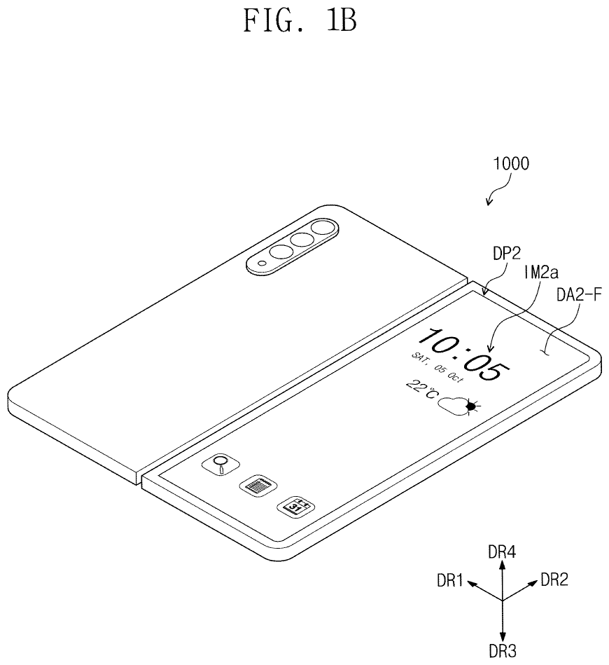

FIG. 1A is a perspective view of an electronic device 1000 according to some embodiments of the present disclosure. FIG. 1B is a rear perspective view of the electronic device 1000 according to some embodiments of the present disclosure.

Referring to FIGS. 1A and 1B, the electronic device 1000 may be a device activated depending on an electrical signal. For example, the electronic device 1000 may display an image and may sense an input applied from the outside. The external input may be a user input. The user input may include various types of external inputs such as a part of a user's body, a pen PN, light, heat, or pressure.

The electronic device 1000 may include a first display panel DP1 and a second display panel DP2. The first display panel DP1 and the second display panel DP2 may be separate panels separated from each other. The first display panel DP1 may be referred to as a main display panel, and the second display panel DP2 may be referred to as an auxiliary display panel or an external display panel.

The first display panel DP1 may include a first display part DA1-F, and the second display panel DP2 may include a second display part DA2-F. The second display panel DP2 may have a smaller area than the first display panel DP1. The first display part DA1-F and the second display part DA2-F may have areas corresponding to the sizes of the first display panel DP1 and the second display panel DP2, respectively, and the first display part DA1-F may have a larger area than the second display part DA2-F.

In an unfolded state of the electronic device 1000, the first display part DA1-F may have a plane parallel (or substantially parallel) to a first direction DR1 and a second direction DR2. The thickness direction of the electronic device 1000 may be parallel to a third direction DR3 that crosses the first direction DR1 and the second direction DR2. Accordingly, front surfaces (or, upper surfaces) and rear surfaces (or, lower surfaces) of members constituting the electronic device 1000 may be defined based on the third direction DR3.

The first display panel DP1 or the first display part DA1-F may include a folding area FA that is folded and unfolded and a plurality of non-folding areas NFA1 and NFA2 spaced apart from each other with the folding area FA therebetween. The second display panel DP2 may overlap one of the plurality of non-folding areas NFA1 and NFA2. For example, the second display panel DP2 may overlap the first non-folding area NFA1.

The display direction of a first image IM1a displayed on a portion of the first display panel DP1, for example, the second non-folding area NFA2 may be opposite to the display direction of a second image IM2a displayed on the second display panel DP2. For example, the first image IM1a may be displayed in the third direction DR3, and the second image IM2a may be displayed in a fourth direction DR4 opposite to the third direction DR3.

According to some embodiments of the present disclosure, the folding area FA may be bent about a folding axis extending in a direction parallel to long sides of the electronic device 1000, for example, in a direction parallel to the second direction DR2. The folding area FA has a certain curvature and a certain radius of curvature in a folded state of the electronic device 1000. The electronic device 1000 may be folded in an in-folding manner such that the first non-folding area NFA1 and the second non-folding area NFA 2 face each other and the first display part DA1-F is not exposed to the outside.

According to some embodiments of the present disclosure, the electronic device 1000 may be folded in an out-folding manner such that the first display part DA1-F is exposed to the outside. According to some embodiments of the present disclosure, the electronic device 1000 may be foldable in an in-folding or out-folding manner in the unfolded state. However, embodiments according to the present disclosure are not limited thereto.

Although FIG. 1A illustrates an example that one folding area FA is defined (or, provided or included) in the electronic device 1000, embodiments according to the present disclosure are not limited thereto. For example, a plurality of folding axes and a plurality of folding areas corresponding thereto may be defined in the electronic device 1000, and the electronic device 1000 may be folded about the plurality of folding axes in an in-folding or out-folding manner in the unfolded state.

According to some embodiments of the present disclosure, at least one of the first display panel DP1 or the second display panel DP2 may sense an input by the pen PN even without a digitizer. Because the digitizer for sensing the pen PN is omitted, an increase in the thickness and weight of the electronic device 1000 and a decrease in the flexibility of the electronic device 1000 depending on the addition of the digitizer may not occur. Accordingly, not only the first display panel DP1 but also the second display panel DP2 may be designed to sense the pen PN.

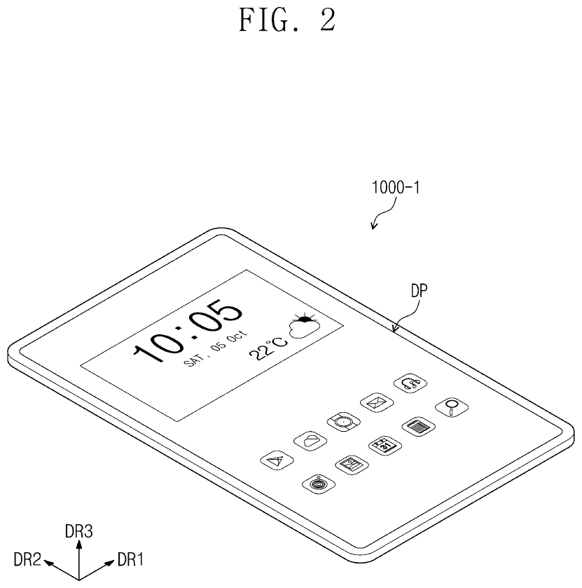

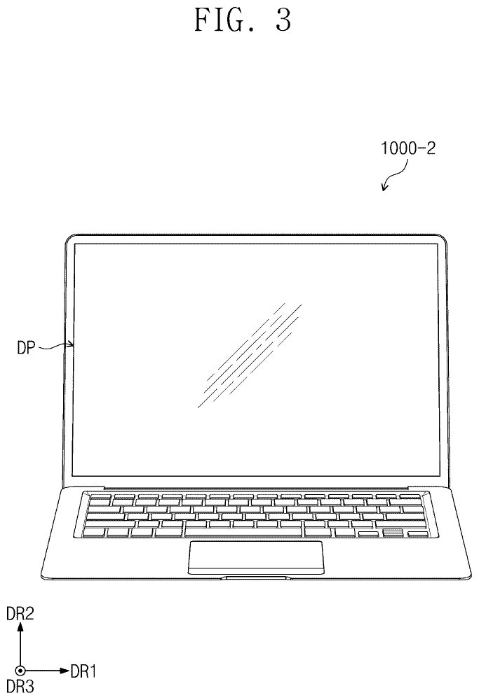

FIG. 2 is a perspective view of an electronic device 1000-1 according to some embodiments of the present disclosure. FIG. 3 is a perspective view of an electronic device 1000-2 according to some embodiments of the present disclosure.

FIG. 2 illustrates an example that the electronic device 1000-1 is a mobile phone, and the electronic device 1000-1 may include a display panel DP. FIG. 3 illustrates an example that the electronic device 1000-2 is a notebook computer, and the electronic device 1000-2 may include the display panel DP. Although FIG. 3 is the perspective view of an electronic device 1000-2, the coordinate axes included in FIG. 3 are displayed based on the display panel DP within the electronic device 1000-2.

According to some embodiments of the present disclosure, the display panel DP may sense an input applied from the outside. The external input may be a user input. The user input may include various types of external inputs such as a part of the user's body, the pen PN (refer to FIG. 1A), light, heat, or pressure.

According to some embodiments of the present disclosure, the display panel DP may sense an input by the pen PN even without a digitizer. Because the digitizer for sensing the pen PN is omitted, an increase in the thickness and weight of the electronic device 1000-1 or 1000-2 depending on the addition of the digitizer may not occur.

Although the foldable electronic device 1000 is illustrated in FIG. 1A and the bar-type electronic device 1000-1 is illustrated in FIG. 2, the present disclosure to be described below is not limited thereto. For example, the following descriptions may be applied to various electronic devices such as a curved electronic device, a rollable electronic device, a slidable electronic device, and a stretchable electronic device.

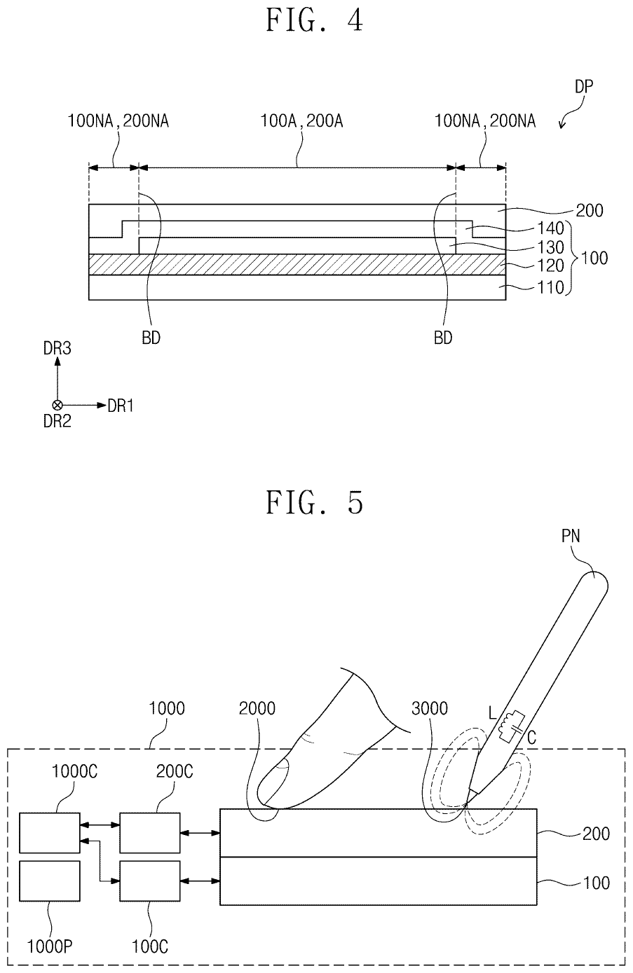

FIG. 4 is a schematic sectional view of the display panel DP according to some embodiments of the present disclosure.

Referring to FIG. 4, the display panel DP may include a display layer 100 and a sensor layer 200.

The display layer 100 may be a component that generates images. A display area 100A and a non-display area 100NA adjacent to (e.g., in a periphery or outside a footprint of) the display area 100A may be defined in the display layer 100. Images may be displayed on the display area 100A.

The display layer 100 may be an emissive display layer. For example, the display layer 100 may be an organic light emitting display layer, an inorganic light emitting display layer, an organic-inorganic light emitting display layer, a quantum-dot display layer, a micro-LED display layer, or a nano-LED display layer. The display layer 100 may include a base layer 110, a circuit layer 120, a light emitting element layer 130, and an encapsulation layer 140.

The base layer 110 may be a member that provides a base surface on which the circuit layer 120 is located. The base layer 110 may have a multi-layer structure or a single-layer structure. The base layer 110 may be a glass substrate, a metal substrate, a silicon substrate, or a polymer substrate, but embodiments according to the present disclosure are not particularly limited thereto.

The circuit layer 120 may be located on the base layer 110. The circuit layer 120 may include an insulating layer, a semiconductor pattern, a conductive pattern, and a signal line. An insulating layer, a semiconductor layer, and a conductive layer may be formed on the base layer 110 by a process such as coating or deposition. The insulating layer, the semiconductor layer, and the conductive layer may be selectively subjected to patterning by performing a photolithography process a plurality of times.

The light emitting element layer 130 may be located on the circuit layer 120. The light emitting element layer 130 may include light emitting elements. For example, the light emitting element layer 130 may include an organic luminescent material, an inorganic luminescent material, an organic-inorganic luminescent material, a quantum dot, a quantum rod, a micro LED, or a nano LED.

The encapsulation layer 140 may be located on the light emitting element layer 130. The encapsulation layer 140 may protect the light emitting element layer 130 from moisture, oxygen, and foreign matter such as dust particles.

The sensor layer 200 may be located on the display layer 100. A sensing area 200A and a peripheral area 200NA adjacent to the sensing area 200A may be defined in the sensor layer 200. The sensing area 200A may overlap the display area 100A, and the peripheral area 200NA may overlap the non-display area 100NA.

According to some embodiments of the present disclosure, the boundary BD between the display area 100A and the non-display area 100NA may overlap the boundary BD between the sensing area 200A and the peripheral area 200NA. However, this is illustrative, and embodiments according to the present disclosure are not particularly limited thereto. For example, the sensing area 200A may have a larger area than the display area 100A. Alternatively, the display area 100A may have a larger area than the sensing area 200A.

The sensor layer 200 may sense an external input applied from the outside. The sensor layer 200 may be an integrated sensor continuously formed in a process of manufacturing the display layer 100. Alternatively, the sensor layer 200 may be an external sensor attached to the display layer 100. The sensor layer 200 may be referred to as a sensor, an input sensing layer, an input sensing panel, or an electronic device for sensing input coordinates.

According to some embodiments of the present disclosure, the sensor layer 200 may sense both an input by a passive input means such as a part of the user's body and an input by an input device that generates a magnetic field having a certain resonant frequency. The input device may be referred to as a pen, an input pen, a magnetic pen, a stylus pen, or an electromagnetic resonance pen.

FIG. 5 is a view for explaining an operation of the electronic device 1000 according to some embodiments of the present disclosure.

Referring to FIG. 5, the electronic device 1000 may include the display layer 100, the sensor layer 200, a display driver 100C, a sensor driver 2000, a main driver 1000C, and a power circuit 1000P.

The sensor layer 200 may sense a first input 2000 or a second input 3000 applied from the outside. Each of the first input 2000 and the second input 3000 may be an input by an input means capable of providing a change in the capacitance of the sensor layer 200 or an input by an input means capable of causing an induced current in the sensor layer 200. For example, the first input 2000 may be an input by a passive input means such as a part of the user's body. The second input 3000 may be an input by the pen PN or an input by an RFIC tag. For example, the pen PN may be a pen of a passive type or a pen of an active type.

According to some embodiments of the present disclosure, the pen PN may be a device that generates a magnetic field having a certain resonant frequency. The pen PN may be configured to transmit an output signal based on an electromagnetic resonance scheme. The pen PN may be referred to as an input device, an input pen, a magnetic pen, a stylus pen, or an electromagnetic resonance pen.

The pen PN may include an RLC resonance circuit, and the RLC resonance circuit may include an inductor L and a capacitor C. According to some embodiments of the present disclosure, the RLC resonance circuit may be a variable resonance circuit that varies the resonant frequency. In this case, the inductor L may be a variable inductor, and/or the capacitor C may be a variable capacitor. However, embodiments according to the present disclosure are not particularly limited thereto.

The inductor L generates a current by a magnetic field formed in the electronic device 1000, for example, the sensor layer 200 or a coil included in the electronic device 1000. However, embodiments according to the present disclosure are not particularly limited thereto. For example, when the pen PN operates in an active type, the pen PN may generate a current even though a magnetic field is not provided to the pen PN from the outside. The generated current is transferred to the capacitor C. The capacitor C charges the current input from the inductor L and discharges the charged current to the inductor L. Thereafter, the inductor L may emit a magnetic field having a resonant frequency. An induced current may flow in the sensor layer 200 by the magnetic field emitted from the pen PN. The induced current may be transferred to the sensor driver 2000 as a reception signal (or, a sensing signal or a signal).

The main driver 1000C may control overall operation of the electronic device 1000. For example, the main driver 1000C may control operations of the display driver 100C and the sensor driver 2000. The main driver 1000C may include at least one microprocessor and may further include a graphic controller. The main driver 1000C may be referred to as an application processor, a central processing unit, or a main processor.

The display driver 1000 may drive the display layer 100. The display driver 100C may receive image data and a control signal from the main driver 1000C. The control signal may include various signals. For example, the control signal may include an input vertical synchronization signal, an input horizontal synchronization signal, a main clock signal, and a data enable signal.

The sensor driver 2000 may drive the sensor layer 200. The sensor driver 2000 may receive a control signal from the main driver 1000C. The control signal may include a clock signal of the sensor driver 2000. In addition, the control signal may further include a mode determination signal for determining a driving mode of the sensor driver 2000 and the sensor layer 200.

The sensor driver 2000 may be implemented with an integrated circuit (IC) and may be electrically connected with the sensor layer 200. For example, the sensor driver 2000 may be directly mounted on a certain area of the display panel. Alternatively, the sensor driver 2000 may be mounted on a separate printed circuit board using a chip on film (COF) method and may be electrically connected with the sensor layer 200.

The sensor driver 2000 and the sensor layer 200 may selectively operate in a first mode or a second mode. For example, the first mode may be a mode for sensing a touch input, for example, the first input 2000. The second mode may be a mode for sensing an input by the pen PN, for example, the second input 3000. The first mode may be referred to as a touch sensing mode, and the second mode may be referred to as a pen sensing mode.

Switching between the first mode and the second mode may be performed in various ways. For example, the sensor driver 2000 and the sensor layer 200 may be driven in the first mode and the second mode in a time-division manner and may sense the first input 2000 and the second input 3000. Alternatively, the switching between the first mode and the second mode may be performed by the user's selection or the user's specific action (or, input), or by activating or deactivating a specific application, one of the first mode and the second mode may be activated or deactivated or the driving mode may be switched from one mode to the other mode. In another case, while the sensor driver 2000 and the sensor layer 200 alternately operate in the first mode and the second mode, when the first input 2000 is sensed, the sensor driver 2000 and the sensor layer 200 may remain in the first mode, and when the second input 3000 is sensed, the sensor driver 2000 and the sensor layer 200 may remain in the second mode.

The sensor driver 2000 may calculate coordinate information of an input based on a signal received from the sensor layer 200 and may provide a coordinate signal having the coordinate information to the main driver 1000C. The main driver 1000C executes an operation corresponding to the user input, based on the coordinate signal. For example, the main driver 1000C may operate the display driver 100C such that a new application image is displayed on the display layer 100.

The power circuit 1000P may include a power management integrated circuit (PMIC). The power circuit 1000P may generate a plurality of driving voltages for driving the display layer 100, the sensor layer 200, the display driver 100C, and the sensor driver 2000. For example, the plurality of driving voltages may include a gate high-voltage, a gate low-voltage, a first driving voltage (e.g., an ELVSS voltage), a second driving voltage (e.g., an ELVDD voltage), an initialization voltage, and the like, but are not particularly limited to the examples.

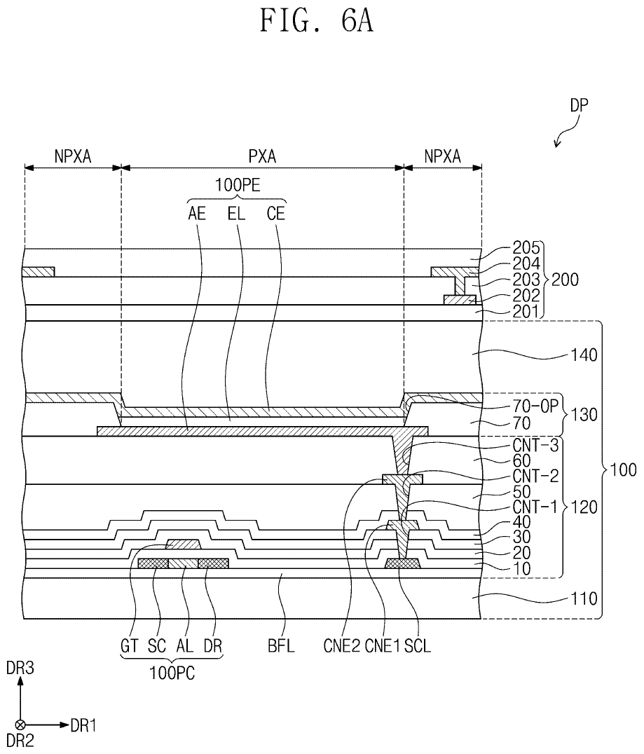

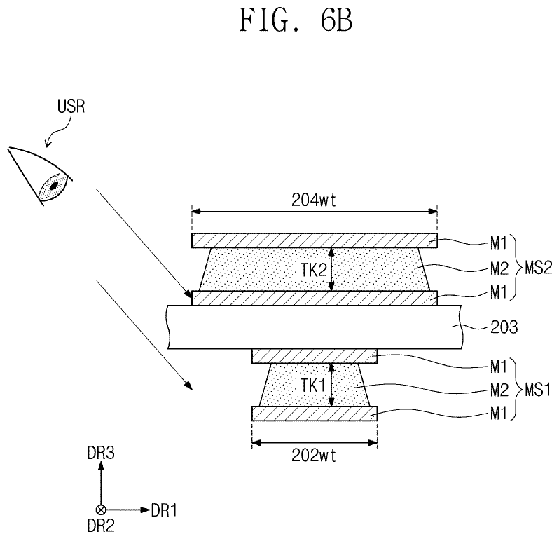

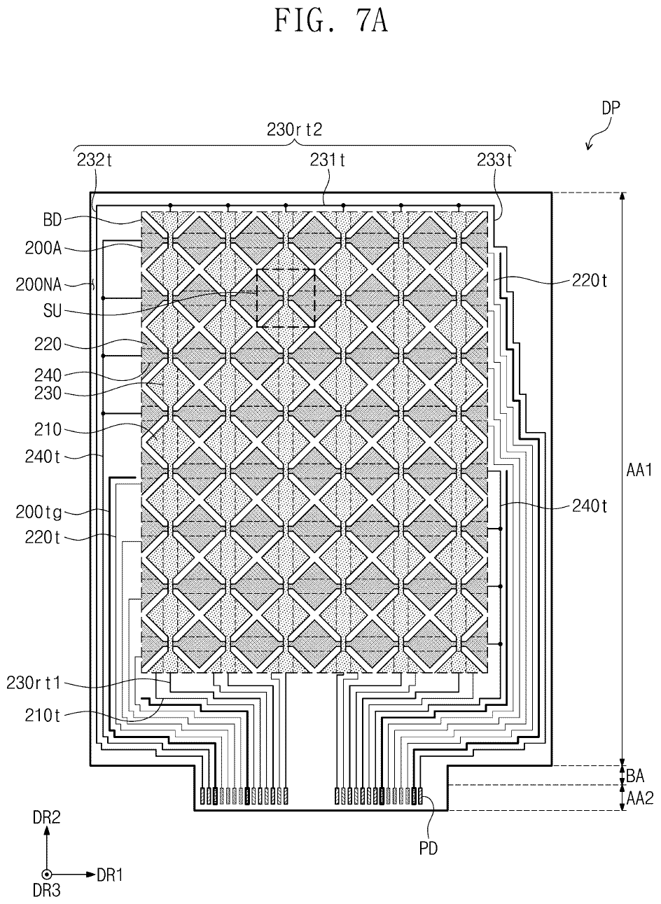

FIG. 6A is a sectional view of the display panel DP according to some embodiments of the present disclosure.

Referring to FIG. 6A, at least one buffer layer BFL is formed on the upper surface of the base layer 110. The buffer layer BFL may relatively improve the coupling force between the base layer 110 and a semiconductor pattern. The buffer layer BFL may be formed of multiple layers. Alternatively, the display layer 100 may further include a barrier layer. The buffer layer BFL may include at least one of silicon oxide, silicon nitride, or silicon oxy nitride. For example, the buffer layer BFL may include a structure in which silicon oxide layers and silicon nitride layers are alternately stacked one above another.

The semiconductor pattern SC, AL, DR, and SCL may be located on the buffer layer BFL. The semiconductor pattern SC, AL, DR, and SCL may include poly silicon. However, without being limited thereto, the semiconductor pattern SC, AL, DR, and SCL may include amorphous silicon, low-temperature polycrystalline silicon, or oxide semiconductor.

FIG. 6A illustrates only a portion of the semiconductor pattern SC, AL, DR, and SCL, and the semiconductor pattern may be additionally located in other areas. The semiconductor pattern SC, AL, DR, and SCL may be arranged over pixels according to a specific rule. The semiconductor pattern SC, AL, DR, and SCL may have different electrical properties depending on whether doping is performed or not. The semiconductor pattern SC, AL, DR, and SCL may include first areas SC, DR, and SCL having a high conductivity and a second area AL having a low conductivity. The first areas SC, DR, and SCL may be doped with an N-type dopant or a P-type dopant. A P-type transistor may include a doped area that is doped with a P-type dopant, and an N-type transistor may include a doped area that is doped with an N-type dopant. The second area AL may be a non-doped area or may be an area more lightly doped than the first areas SC, DR, and SCL.

The first areas SC, DR, and SCL may have a higher conductivity than the second area AL and may serve as electrodes or signal lines. The second area AL may correspond (or substantially correspond) to an active area AL (or, a channel) of a transistor 100PC. In other words, one portion AL of the semiconductor pattern SC, AL, DR, and SCL may be the active area AL of the transistor 100PC, another portion SC or DR of the semiconductor pattern SC, AL, DR, and SCL may be a source area SC or a drain area DR of the transistor 100PC, and the other portion SCL of the semiconductor pattern SC, AL, DR, and SCL may be a connecting electrode or a connecting signal line SCL.

Each of the pixels may have an equivalent circuit including a plurality of transistors, one capacitor, and at least one light emitting element, and the equivalent circuit of the pixel may be modified in various forms. In FIG. 6A, one transistor 100PC and one light emitting element 100PE that are included in the pixel are illustrated.

The source area SC, the active area AL, and the drain area DR of the transistor 100PC may be formed from the semiconductor pattern SC, AL, DR, and SCL. The source area SC and the drain area DR may extend from the active area AL in opposite directions on the section. In FIG. 6A, a portion of the connecting signal line SCL formed from the semiconductor pattern SC, AL, DR, and SCL is illustrated. Although not separately illustrated, the connecting signal line SCL may be connected to the drain area DR of the transistor 100PC when viewed from above the plane.

A first insulating layer 10 may be located on the buffer layer BFL. The first insulating layer 10 may commonly overlap the plurality of pixels and may cover the semiconductor pattern SC, AL, DR, and SCL. The first insulating layer 10 may be an inorganic layer and/or an organic layer and may have a single-layer structure or a multi-layer structure. The first insulating layer 10 may include at least one of aluminum oxide, titanium oxide, silicon oxide, silicon nitride, silicon oxy nitride, zirconium oxide, or hafnium oxide. According to some embodiments, the first insulating layer 10 may be a single silicon oxide layer. Not only the first insulating layer 10 but also insulating layers of the circuit layer 120 that will be described below may be inorganic layers and/or organic layers and may have a single-layer structure or a multi-layer structure. The inorganic layers may include at least one of the aforementioned materials, but embodiments according to the present disclosure are not limited thereto.

A gate GT of the transistor 100PC is located on the first insulating layer 10. The gate GT may be a portion of a metal pattern. The gate GT overlaps the active area AL. The gate GT may function as a mask in a process of doping or reducing the semiconductor pattern SC, AL, DR, and SCL.

A second insulating layer 20 may be located on the first insulating layer 10 and may cover the gate GT. The second insulating layer 20 may commonly overlap the pixels. The second insulating layer 20 may be an inorganic layer and/or an organic layer and may have a single-layer structure or a multi-layer structure. The second insulating layer 20 may include at least one of silicon oxide, silicon nitride, or silicon oxy nitride. According to some embodiments, the second insulating layer 20 may have a multi-layer structure including a silicon oxide layer and a silicon nitride layer.

A third insulating layer 30 may be located on the second insulating layer 20. The third insulating layer 30 may have a single-layer structure or a multi-layer structure. For example, the third insulating layer 30 may have a multi-layer structure including a silicon oxide layer and a silicon nitride layer.

A first connecting electrode CNE1 may be located on the third insulating layer 30. The first connecting electrode CNE1 may be connected to the connecting signal line SCL through a contact hole CNT-1 penetrating the first, second, and third insulating layers 10, 20, and 30.

A fourth insulating layer 40 may be located on the third insulating layer 30. The fourth insulating layer 40 may be a single silicon oxide layer. A fifth insulating layer 50 may be located on the fourth insulating layer 40. The fifth insulating layer 50 may be an organic layer.

A second connecting electrode CNE2 may be located on the fifth insulating layer 50. The second connecting electrode CNE2 may be connected to the first connecting electrode CNE1 through a contact hole CNT-2 penetrating the fourth insulating layer 40 and the fifth insulating layer 50.

A sixth insulating layer 60 may be located on the fifth insulating layer 50 and may cover the second connecting electrode CNE2. The sixth insulating layer 60 may be an organic layer.

The light emitting element layer 130 may be located on the circuit layer 120. The light emitting element layer 130 may include the light emitting element 100PE. For example, the light emitting element layer 130 may include an organic luminescent material, an inorganic luminescent material, an organic-inorganic luminescent material, a quantum dot, a quantum rod, a micro LED, or a nano LED. Hereinafter, it will be described that the light emitting element 100PE is an organic light emitting element. However, embodiments according to the present disclosure are not particularly limited thereto.

The light emitting element 100PE may include a first electrode AE, an emissive layer EL, and a second electrode CE.

The first electrode AE may be located on the sixth insulating layer 60. The first electrode AE may be connected to the second connecting electrode CNE2 through a contact hole CNT-3 penetrating the sixth insulating layer 60.

A pixel defining layer 70 may be located on the sixth insulating layer 60 and may cover a portion of the first electrode AE. The pixel defining layer 70 has an opening 70-OP defined therein. The opening 70-OP of the pixel defining layer 70 exposes at least a portion of the first electrode AE.

The first display part DA1-F (refer to FIG. 1A) may include an emissive area PXA and a non-emissive area NPXA adjacent to the emissive area PXA. The non-emissive area NPXA may surround the emissive area PXA. According to some embodiments, the emissive area PXA is defined to correspond to a partial area of the first electrode AE exposed by the opening 70-OP.

The emissive layer EL may be located on the first electrode AE. The emissive layer EL may be located in an area corresponding to the opening 70-OP. Although FIG. 6A illustrates an example that the emissive layer EL is located in the opening 70-OP, embodiments according to the present disclosure are not particularly limited thereto. For example, the emissive layer EL may extend to cover the side surface of the pixel defining layer 70 that defines the opening 70-Op and a portion of the upper surface of the pixel defining layer 70.

According to some embodiments of the present disclosure, the emissive layer EML may be separately formed in each of the pixels. When the emissive layer EL is separately formed in each of the pixels, the emissive layers EL may each emit at least one of blue light, red light, or green light. However, without being limited thereto, the emissive layer EL may have a one-body shape and may be commonly included in the plurality of pixels. In this case, the emissive layer EL may provide blue light or white light.

The second electrode CE may be located on the emissive layer EL. The second electrode CE may have a one-body shape and may be commonly included in the plurality of pixels.

According to some embodiments of the present disclosure, a hole control layer may be located between the first electrode AE and the emissive layer EL. The hole control layer may be commonly arranged in the emissive area PXA and the non-emissive area NPXA. The hole control layer may include a hole transport layer and may further include a hole injection layer. An electron control layer may be located between the emissive layer EL and the second electrode CE. The electron control layer may include an electron transport layer and may further include an electron injection layer. The hole control layer and the electron control layer may be commonly formed in the plurality of pixels using an open mask or an ink-jet process.

The encapsulation layer 140 may be located on the light emitting element layer 130. The encapsulation layer 140 may include an inorganic layer, an organic layer, and an inorganic layer sequentially stacked one above another. However, layers constituting the encapsulation layer 140 are not limited thereto. The inorganic layers may protect the light emitting element layer 130 from moisture and oxygen, and the organic layer may protect the light emitting element layer 130 from foreign matter such as dust particles. The inorganic layers may include a silicon nitride layer, a silicon oxy nitride layer, a silicon oxide layer, a titanium oxide layer, or an aluminum oxide layer. The organic layer may include an acrylic organic layer, but is not limited thereto.

The sensor layer 200 may include a base layer 201, a first conductive layer 202, an intermediate insulating layer 203, a second conductive layer 204, and a cover insulating layer 205.

The base layer 201 may be an inorganic layer including at least one of silicon nitride, silicon oxy nitride, or silicon oxide. Alternatively, the base layer 201 may be an organic layer including an epoxy resin, an acrylic resin, or an imide-based resin. The base layer 201 may have a single-layer structure or may have a multi-layer structure stacked in the third direction DR3. According to some embodiments of the present disclosure, the sensor layer 200 may not include the base layer 201.

Each of the first conductive layer 202 and the second conductive layer 204 may have a single-layer structure or may have a multi-layer structure stacked in the third direction DR3.

Each of the first conductive layer 202 and the second conductive layer 204 that have a single-layer structure may include a metal layer or a transparent conductive layer. The metal layer may include molybdenum, silver, titanium, copper, aluminum, or an alloy thereof. The transparent conductive layer may include transparent conductive oxide such as indium tin oxide (ITO), indium zinc oxide (IZO), zinc oxide (ZnO), indium zinc tin oxide (IZTO), or the like. In addition, the transparent conductive layer may include a conductive polymer such as poly(3,4-ethylenedioxythiophene) (PEDOT), a metal nano wire, or graphene.

Each of the first conductive layer 202 and the second conductive layer 204 that have a multi-layer structure may include metal layers. The meal layers may have, for example, a three-layer structure of titanium/aluminum/titanium. The conductive layers having the multi-layer structure may include at least one metal layer and at least one transparent conductive layer.

According to some embodiments of the present disclosure, the thickness of the first conductive layer 202 may be greater than or equal to the thickness of the second conductive layer 204. When the thickness of the first conductive layer 202 is greater than the thickness of the second conductive layer 204, the resistance of a component (e.g., an electrode, a sensing pattern, or a bridge pattern) included in the first conductive layer 202 may be decreased. In addition, because the first conductive layer 202 is located under the second conductive layer 204, the probability that components included in the first conductive layer 202 will be visually recognized due to reflection of external light may be lower than that of the second conductive layer 204 even though the thickness of the first conductive layer 202 is increased.

At least one of the intermediate insulating layer 203 or the cover insulating layer 205 may include an inorganic film. The inorganic film may include at least one of aluminum oxide, titanium oxide, silicon oxide, silicon nitride, silicon oxy nitride, zirconium oxide, or hafnium oxide.

At least one of the intermediate insulating layer 203 or the cover insulating layer 205 may include an organic film. The organic film may include at least one of an acrylic resin, a methacrylic resin, a polyisoprene resin, a vinyl resin, an epoxy resin, a urethane-based resin, a celluosic resin, a siloxane-based resin, a polyimide resin, a polyamide resin, or a perylene-based resin.

Although it has been described that the sensor layer 200 includes the first conductive layer 202 and the second conductive layer 204, that is, a total of two conductive layers, embodiments according to the present disclosure are not particularly limited thereto. For example, the sensor layer 200 may include three or more conductive layers.

FIG. 6B is a sectional view of the sensor layer 200 according to some embodiments of the present disclosure.

Referring to FIGS. 6A and 6B, a second width 204wt of a second mesh line MS2 included in the second conductive layer 204 may be greater than or equal to a first width 202wt of a first mesh line MS1 included in the first conductive layer 202. When a user USR looks at the first mesh line MS1 and the second mesh line MS2 from the side, the probability that the first mesh line MS1 will be visually recognized by the user USR may be decreased because the first mesh line MS1 has a smaller width than the second mesh line MS2.

Each of the first mesh line MS1 and the second mesh line MS2 may include first metal layers M1 and a second metal layer M2 located between the first metal layers M1. For example, the first metal layers M1 may include titanium (Ti), and the second metal layer M2 may include aluminum (AI). However, this is illustrative, and embodiments according to the present disclosure are not particularly limited thereto.

According to some embodiments of the present disclosure, a first thickness TK1 of the second metal layer M2 of the first mesh line MS1 and a second thickness TK2 of the second metal layer M2 of the second mesh line MS2 may be the same (or substantially the same) as each other, but embodiments according to the present disclosure are not particularly limited thereto. For example, the first thickness TK1 may be greater than the second thickness TK2. Alternatively, the second thickness TK2 may be greater than the first thickness TK1. Because the first mesh line MS1 is located under the second mesh line MS2, the probability that the first mesh line MS1 will be visually recognized due to reflection of external light may be lower than that of the second mesh line MS2 even though the thickness of the first mesh line MS1 is increased. According to some embodiments of the present disclosure, each of the first thickness TK1 and the second thickness TK2 may be 1000 angstroms or more, for example, 6000 angstroms.

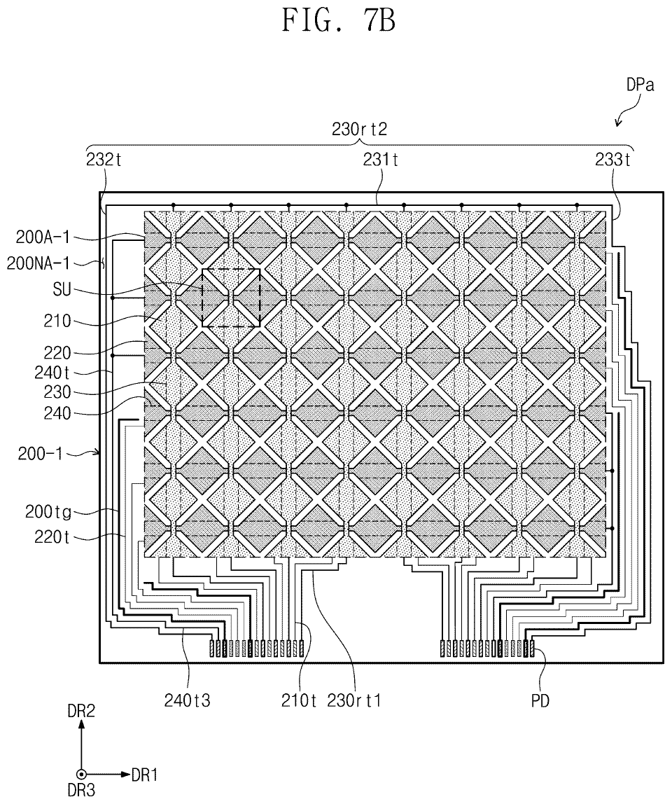

FIG. 7A is a plan view of the display panel DP according to some embodiments of the present disclosure.

Referring to FIG. 7A, the display panel DP includes the sensor layer 200. The display panel DP may include a first area AA1, a bending area BA, and a second area AA2. The bending area BA may be located between the first area AA1 and the second area AA2 spaced apart from each other in the second direction DR2. The width of the bending area BA and the width (or, length) of the second area AA2 that are parallel to the first direction DR1 may be smaller than the width (or, length) of the first area AA1 that is parallel to the first direction DR1. An area having a smaller length in the direction of a bending axis may be more easily bent.

The plan view illustrated in FIG. 7A is a plan view in an unfolded state before the display panel DP is assembled with other components, that is, before the display panel DP is modularized. A portion of the display panel DP may be bent and modularized. For example, the bending area BA may be bent such that the second area AA2 is located under the first area AA1.

Referring to FIG. 7A, the sensing area 200A and the peripheral area 200NA adjacent to the sensing area 200A may be defined in the sensor layer 200. The sensor layer 200 may include a plurality of first electrodes 210, a plurality of second electrodes 220, a plurality of third electrodes 230, and a plurality of fourth electrodes 240 located in the sensing area 200A.

Each of the first electrodes 210 may cross the second electrodes 220. Each of the first electrodes 210 may extend in the second direction DR2. The first electrodes 210 may be arranged in the first direction DR1 so as to be spaced apart from one another. Each of the second electrodes 220 may extend in the first direction DR1. The second electrodes 220 may be arranged in the second direction DR2 so as to be spaced apart from one another. A sensing unit SU of the sensor layer 200 may be an area where one first electrode 210 and one second electrode 220 cross each other.

In FIG. 7A, six first electrodes 210 and eight second electrodes 220 are illustrated as an example, and 48 sensing units SU are illustrated as an example. However, the number of first electrodes 210 and the number of second electrodes 220 are not limited thereto.

According to some embodiments of the present disclosure, the width of the sensing area 200A in the second direction DR2 may be greater than or equal to the width of the sensing area 200A in the first direction DR1. Accordingly, the number of first electrodes 210 arranged in the first direction DR1 may be smaller than the number of second electrodes 220 arranged in the second direction DR2.

Each of the third electrodes 230 may extend in the second direction DR2. The third electrodes 230 may be arranged in the first direction DR1 so as to be spaced apart from one another. One third electrode 230 may overlap one first electrode 210. The expression “A overlap B” used herein may mean that a portion of A overlaps a portion of B, the entirety of A overlaps a portion of B, the entirety of B overlaps a portion of A, or the entirety of A overlaps the entirety of B.

According to some embodiments of the present disclosure, capacitance (or, coupling capacitance) between one first electrode 210 and one third electrode 230 may be adjusted by adjusting an overlapping area between the one first electrode 210 and the one third electrode 230. The third electrodes 230 may be referred to as first auxiliary electrodes or charging electrodes.

The fourth electrodes 240 may be arranged in the second direction DR2. The fourth electrodes 240 may extend in the first direction DR1. One fourth electrode 240 may at least partially overlap one second electrode 220. According to some embodiments of the present disclosure, capacitance (or, coupling capacitance) between one second electrode 220 and one fourth electrode 240 may be adjusted by adjusting an overlapping area between the one second electrode 220 and the one fourth electrode 240. The fourth electrodes 240 may be referred to as auxiliary sensing electrodes or second auxiliary electrodes.

According to some embodiments of the present disclosure, at least some of the fourth electrodes 240 may be electrically connected to form one electrode group. For example, FIG. 7A illustrates an example that four fourth electrodes 240 are connected to one trace line, for example, an auxiliary trace line 240t to form one electrode group. Accordingly, in FIG. 7A, two electrode groups are illustrated as being arranged in the second direction DR2. However, the number of fourth electrodes 240 constituting one electrode group is not limited thereto. For example, the number of fourth electrodes 240 constituting one electrode group may be eight, and in this case, the sensor layer 200 may include one electrode group.

The sensor layer 200 may further include a plurality of first trace lines 210t and a plurality of second trace lines 220t located in the peripheral area 200NA. The first trace lines 210t and the second trace lines 220t may be arranged to overlap the non-display area 100NA of the display layer 100 (refer to FIG. 4). The first trace lines 210t may be electrically connected to the first electrodes 210 in a one-to-one correspondence. The second trace lines 220t may be electrically connected to the second electrodes 220 in a one-to-one correspondence. Some of the second trace lines 220t and the other second trace lines 220t may be spaced apart from each other with the sensing area 200A therebetween.

According to some embodiments of the present disclosure, the first trace lines 210t may be arranged in the first direction DR1 that is the same as the arrangement direction of the first electrodes 210, and the second trace lines 220t may be arranged in the first direction DR1 that is different from the arrangement direction of the second electrodes 220. In addition, the second trace lines 22t may be longer than the first trace lines 210t.

According to some embodiments of the present disclosure, in a pen sensing driving mode for sensing a pen input, the sensor driver 2000 (refer to FIG. 5) may calculate a coordinate with respect to an axis parallel to the first direction DR1 based on a signal received from the first electrodes 210 and may calculate a coordinate with respect to an axis parallel to the second direction DR2 based on a signal received from the second electrodes 220.

The arrangement direction of the second trace lines 220t may be different from the arrangement direction of the second electrodes 220 to which the second trace lines 220t are electrically connected, and the second trace lines 220t may be longer than the first trace lines 210t. Accordingly, induced currents induced in the second trace lines 220t may cause noise in the calculation of coordinates. According to some embodiments of the present disclosure, the sensor driver 2000 may differentially sense signals received from two different second electrodes among the second electrodes. In this case, an influence of the second trace lines 220t may be removed so that noise affecting coordinate distortion may be relatively reduced or removed. Thus, the accuracy (e.g., linearity) of coordinates sensed by the sensor layer 200 and the sensor driver 2000 may be relatively improved.

The sensor layer 200 may further include a plurality of first auxiliary trace lines 230rt1, a second auxiliary trace line 230rt2, and auxiliary trace lines 240t.

According to some embodiments of the present disclosure, at least one of the third electrodes 230, at least one of the first auxiliary trace lines 230rt1, and the second auxiliary trace line 230rt2 may form one loop. A magnetic field may be formed by a current path defined by the one loop. The magnetic field may be used to charge an external input device, for example, a pen. Accordingly, the first auxiliary trace lines 230rt1 may be referred to as first loop trace lines, and the second auxiliary trace line 230rt2 may be referred to as a second loop trace line. The third electrodes 230 may be referred to as charging electrodes, loop electrodes, or first auxiliary electrodes.

The first auxiliary trace lines 230rt1 may be connected to the third electrodes 230 in a one-to-one correspondence. That is, the number of first auxiliary trace lines 230rt1 may correspond to the number of third electrodes 230. In FIG. 7A, six first auxiliary trace lines 230rt1 and six third electrodes 230 are illustrated as an example.

According to some embodiments of the present disclosure, one first auxiliary trace line may be electrically connected with a plurality of third electrodes. The plurality of third electrodes connected to the one first auxiliary trace line may be referred to as one electrode group. As the number of parallel-connected third electrodes included in one electrode group is increased, the resistance of the one electrode group may be lowered, and thus power efficiency and sensing sensitivity may be relatively improved. In contrast, as the number of third electrodes included in one electrode group is decreased, a coil pattern formed using the one electrode group may be implemented in more various forms.

The second auxiliary trace line 230rt2 may be electrically connected with the third electrodes 230. According to some embodiments of the present disclosure, the second auxiliary trace line 230rt2 may be electrically connected with all of the third electrodes 230.

The second auxiliary trace line 230rt2 may include a first line portion 231t that extends in the first direction DR1 and that is electrically connected to the third electrodes 230, a second line portion 232t extending from a first end of the first line portion 231t in the second direction DR2, and a third line portion 233t extending from a second end of the first line portion 231t in the second direction DR2.

According to some embodiments of the present disclosure, each of the resistance of the second line portion 232t and the resistance of the third line portion 233t may be the same (or substantially the same) as the resistance of one third electrode among the third electrodes 230. To adjust the resistance of the second line portion 232t and the resistance of the third line portion 233t, the widths of the second line portion 232t and the third line portion 233t in the first direction DR1 may be adjusted. However, this is merely illustrative, and the first to third line portions 231t, 232t, and 233t may have the same (or substantially the same) width.

According to some embodiments of the present disclosure, the second auxiliary trace line 230rt2 may be provided in a form that surrounds the area where the first trace lines 210t, the second trace lines 220t, the auxiliary trace lines 240t, and the first auxiliary trace lines 230rt1 are located. The second line portion 232t and the third line portion 233t may serve as the third electrodes 230, and the same effect as placing the third electrodes 230 in the peripheral area 200NA may be obtained. For example, one of the second line portion 232t and the third line portion 233t and one of the third electrodes 230 may form a coil. Accordingly, a pen located in an area adjacent to the peripheral area 200NA may also be sufficiently charged by a current loop including the second line portion 232t or the third line portion 233t.

The auxiliary trace lines 240t may be spaced apart from each other with the sensing area 200A therebetween. FIG. 7A illustrates an example that two electrode groups are arranged. The auxiliary trace line 240t connected to four fourth electrodes 240 located on the upper side and the auxiliary trace line 240t connected to four fourth electrodes 240 located on the lower side may be spaced apart from each other with the sensing area 200A therebetween. However, embodiments according to the present disclosure are not particularly limited thereto.

The sensor layer 200 may further include a plurality of guard lines 200tg located in the peripheral area 200NA. Depending on an operation mode of the sensor layer 200, each of the guard lines 200tg may be grounded or floated, or may receive a certain signal. For example, when the sensor layer 200 operates in a mutual-capacitance detection mode or the pen sensing driving mode, the guard lines 200tg may be grounded. When the sensor layer 200 operates in a self-capacitance detection mode, a signal the same as the signal provided to adjacent trace lines may be provided to the guard lines 200tg. Accordingly, parasitic capacitance formed between the trace lines may be relatively reduced or removed by the guard lines 200tg. When the sensor layer 200 operates in a pen charging driving mode, the guard lines 200tg may be floated. When the guard lines 200tg are floated, this may mean that a signal is not provided to pads connected to the guard lines 200tg.

The sensor layer 200 may further include a plurality of pads PD located in the peripheral area 200NA. Although FIG. 7A illustrates an example that the pads PD are arranged in one row in the first direction DR1, embodiments according to the present disclosure are not particularly limited thereto. For example, the pads PD may be arranged in a plurality of rows. The pads PD may be electrically connected to the first trace lines 210t, the second trace lines 220t, the first auxiliary trace lines 230rt1, opposite ends of the second auxiliary trace line 230rt2, the auxiliary trace lines 240t, and the guard lines 200tg, which have been described above, in a one-to-one correspondence.

FIG. 7B is a plan view of a display panel DPa according to some embodiments of the present disclosure.

Referring to FIGS. 4 and 7B, the display panel DPa includes a sensor layer 200-1. A sensing area 200A-1 and a peripheral area 200NA-1 adjacent to the sensing area 200A-1 may be defined in the sensor layer 200-1.

A base layer 110 of the display panel DPa may be a rigid glass substrate. Accordingly, unlike in the embodiments described above with reference to FIG. 7A, the display panel DPa may not include a bending area. However, this is illustrative, and embodiments according to the present disclosure are not particularly limited thereto.

According to some embodiments of the present disclosure, the width of the sensing area 200A-1 in the first direction DR1 may be greater than or equal to the width of the sensing area 200A-1 in the second direction DR2. Accordingly, the number of first electrodes 210 arranged in the first direction DR1 may be larger than the number of second electrodes 220 arranged in the second direction DR2. In FIG. 7B, eight first electrodes 210 and six second electrodes 220 located in the sensing area 200A-1 are illustrated as an example, and 48 sensing units SU are illustrated as an example. However, the number of first electrodes 210 and the number of second electrodes 220 are not limited thereto.

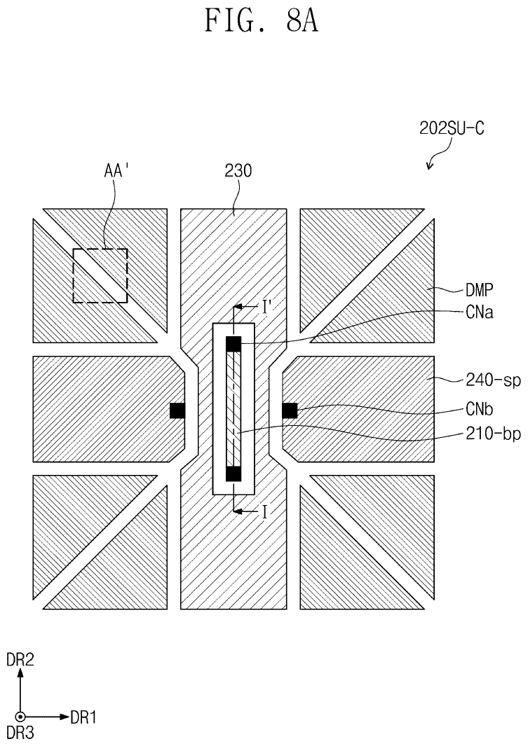

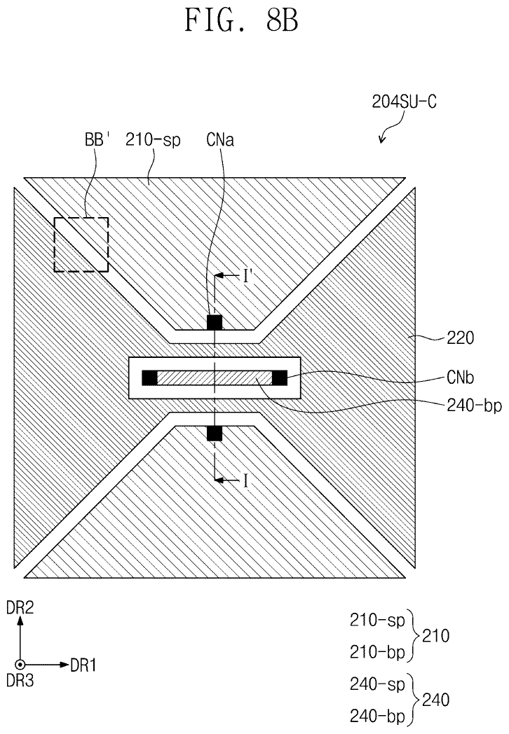

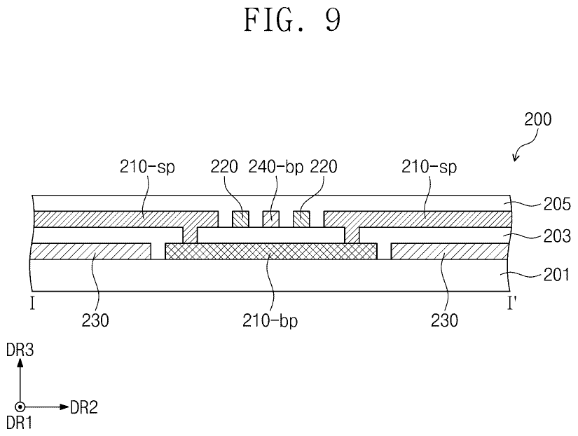

FIG. 8A is a plan view illustrating a first conductive layer 202SU-C of the sensing unit SU (refer to FIG. 7A) according to some embodiments of the present disclosure. FIG. 8B is a plan view illustrating a second conductive layer 204SU-C of the sensing unit SU (refer to FIG. 7A) according to some embodiments of the present disclosure. FIG. 9 is a sectional view of the sensor layer 200 taken along line I-I′ illustrated in each of FIGS. 8A and 8B according to some embodiments of the present disclosure.

FIGS. 8A and 8B illustrate the shapes of the first conductive layer 202SU-C and the second conductive layer 204SU-C of the sensing unit SU. However, the illustrated shapes are illustrative, and the shapes of the first conductive layer 202SU-C and the second conductive layer 204SU-C are not limited thereto.

Referring to FIGS. 8A, 8B, and 9, the first electrode 210 may include first sensing patterns 210-sp and a first bridge pattern 210-bp. The first sensing patterns 210-sp and the first bridge pattern 210-bp may be electrically connected with each other through a first contact CNa. The second electrode 220 may be located on the same layer as the first sensing patterns 210-sp. For example, the first sensing patterns 210-sp may be spaced apart from each other with the second electrode 220 therebetween. The first bridge pattern 210-bp may be located on a layer different from the layer on which the second electrode 220 is located. The first bridge pattern 210-bp may be insulated from the second electrode 220 and may cross the second electrode 220.

The third electrode 230 may be located on the same layer as the first bridge pattern 210-bp. An opening may be defined in the third electrode 230 to surround the first bridge pattern 210-bp. The third electrode 230 may overlap the first sensing patterns 210-sp. Accordingly, a coupling capacitor may be defined between the first electrode 210 and the third electrode 230.

The fourth electrode 240 may include second sensing patterns 240-sp and a second bridge pattern 240-bp. The second sensing patterns 240-sp and the second bridge pattern 240-bp may be electrically connected with each other through a second contact CNb. The third electrode 230 may be located on the same layer as the second sensing patterns 240-sp. For example, the second sensing patterns 240-sp may be spaced apart from each other with the third electrode 230 therebetween. The second bridge pattern 240-bp may be located on a layer different from the layer on which the third electrode 230 is located. The second bridge pattern 240-bp may be insulated from the third electrode 230 and may cross the third electrode 230.

According to some embodiments of the present disclosure, the first conductive layer 202SU-C may include the first bridge pattern 210-bp, the third electrode 230, and the second sensing patterns 240-sp. The second conductive layer 204SU-C may include the first sensing patterns 210-sp, the second electrode 220, and the second bridge pattern 240-bp.

According to some embodiments of the present disclosure, the first conductive layer 202SU-C may further include dummy patterns DMP. Because the dummy patterns DMP are located in empty spaces, the probability that specific patterns will be visually recognized due to reflection of external light may be decreased. That is, the electronic device 1000 (refer to FIG. 1A) in which visibility depending on reflection of external light is relatively improved may be provided. Each of the dummy patterns DMP may be electrically floated or electrically grounded. According to some embodiments of the present disclosure, the dummy patterns DMP may be omitted.

Referring to FIGS. 8A and 8B, in the second conductive layer 204SU-C in the sensing unit SU, the area occupied by components included in the first electrode 210 and the second electrode 220 may be larger than the area occupied by components included in the third electrode 230 and the fourth electrode 240. A change in capacitance by the first input 2000 (refer to FIG. 4) may be increased as the distance is decreased. Accordingly, a component for sensing the first input 2000 (refer to FIG. 4) may be located in a relatively large area in a layer adjacent to the surface of the electronic device 1000 (refer to FIG. 1A). Thus, touch performance may be relatively improved.

Although FIGS. 6A to 9 illustrate the structure in which the first to fourth electrodes 210, 220, 230, and 240 are distributed and arranged in the two conductive layers 202SU-C and 204SU-C, embodiments according to the present disclosure are not particularly limited thereto. For example, the first to fourth electrodes 210, 220, 230, and 240 may be distributed and arranged in three or four conductive layers.

According to some embodiments of the present disclosure, the third electrode 230 to which a signal is applied in the charging driving mode may be included in a third conductive layer located under the first and second conductive layers 202SU-C and 204SU-C. For example, the third conductive layer may be provided under the base layer 201. The third conductive layer may be located between the base layer 201 and the display layer 100, may be located under the display layer 100, or may be included in the display layer 100.

The first, second, and fourth electrodes 210, 220, and 240 may be included in the first and second conductive layers 202SU-C and 204SU-C. For example, when the third electrode 230 is implemented as a separate conductive layer such as the third conductive layer, the shape of the third electrode 230 may be more freely designed. For example, the third electrode 230 may be provided in a form including a plurality of coils. In addition, the third electrode 230 may be more densely provided using the third conductive layer. In this case, pen sensing sensitivity may be relatively improved. According to some embodiments of the present disclosure, the fourth electrode 240 instead of the third electrode 230 may be included in the third conductive layer.

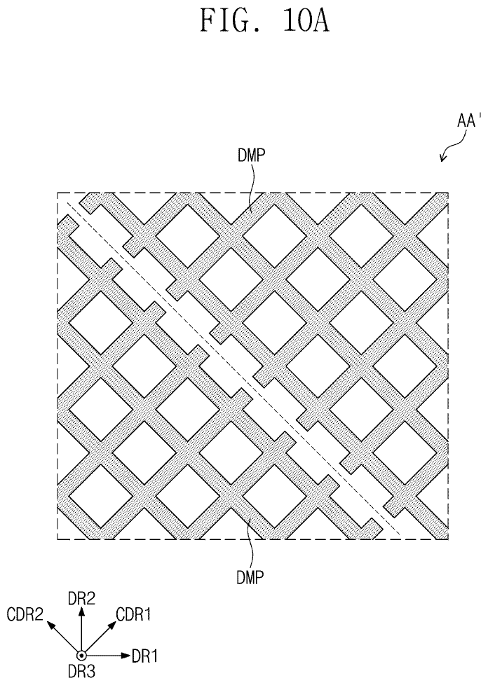

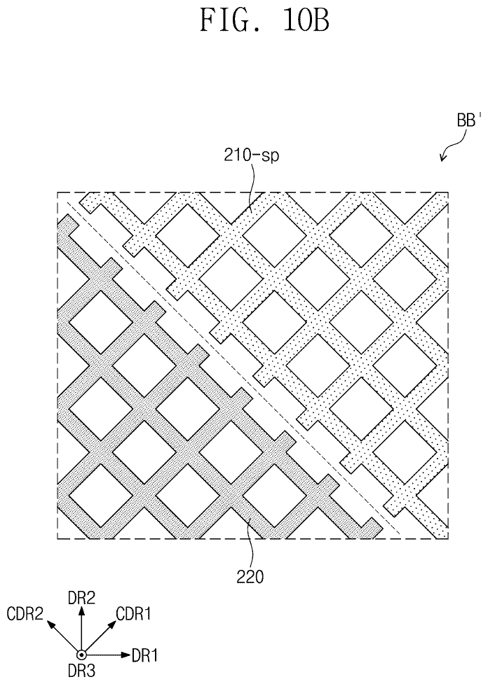

FIG. 10A is an enlarged plan view of area AA′ illustrated in FIG. 8A. FIG. 10B is an enlarged plan view of area BB′ illustrated in FIG. 8B.

Referring to FIGS. 8A, 8B, 10A, and 10B, the first electrodes 210, the second electrodes 220, the third electrodes 230, the fourth electrodes 240, and the dummy patterns DMP may each have a mesh structure. The mesh structure may include a plurality of mesh lines. Each of the plurality of mesh lines may have a shape extending in a certain direction. The plurality of mesh lines may be connected with one another. The shape may have various shapes such as a straight line, a line having protrusions, and an uneven line. Openings where the mesh structure is not located may be defined (or, provided or formed) in each of the first electrodes 210, the second electrodes 220, the third electrodes 230, the fourth electrodes 240, and the dummy patterns DMP.

FIGS. 10A and 10B illustrate an example that the mesh structure includes mesh lines extending in a first crossing direction CDR1 that crosses the first direction DR1 and the second direction DR2 and mesh lines extending in a second crossing direction CDR2 that crosses the first crossing direction CDR1. However, the extension directions of the mesh lines constituting the mesh structure are not particularly limited to those illustrated in FIGS. 10A and 10B. For example, the mesh structure may include only mesh lines extending in the first direction DR1 and the second direction DR2, or may include mesh lines extending in the first direction DR1, the second direction DR2, the first crossing direction CDR1, and the second crossing direction CDR2. That is, the mesh structure may be modified in various forms.

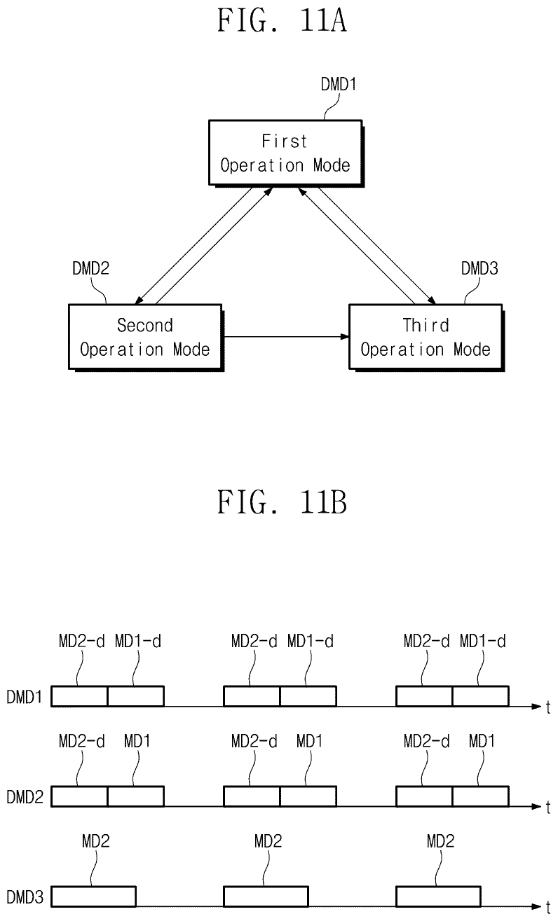

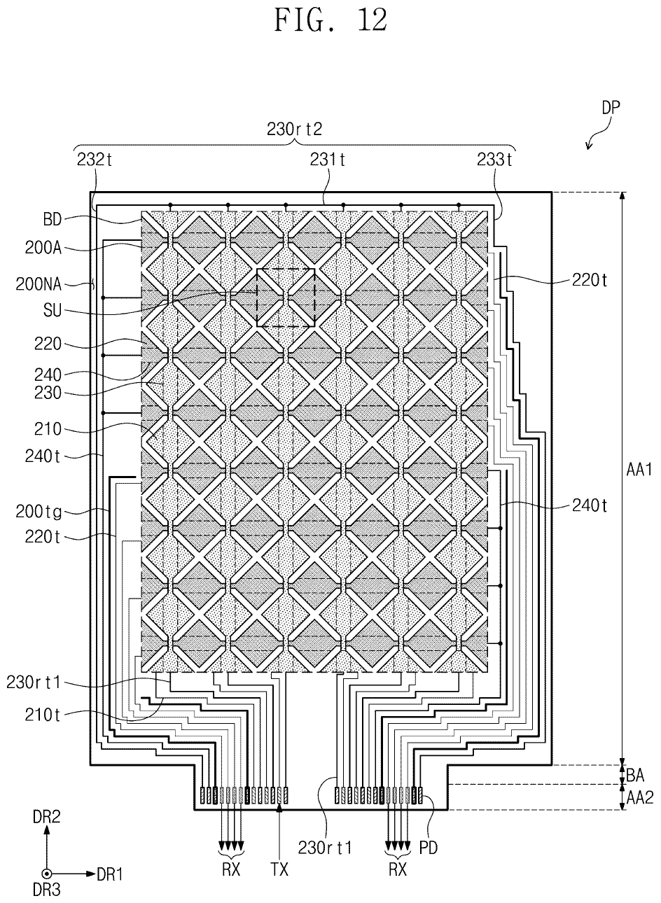

FIG. 11A is a view illustrating an operation of the sensor driver 2000 according to some embodiments of the present disclosure.

Referring to FIGS. 5 and 11A, the sensor driver 2000 may be selectively driven in one of a first operation mode DMD1, a second operation mode DMD2, and a third operation mode DMD3.

The first operation mode DMD1 may be referred to as a touch and pen standby mode, the second operation mode DMD2 may be referred to as a touch activation and pen standby mode, and the third operation mode DMD3 may be referred to as a pen activation mode. The first operation mode DMD1 may be a mode in which the sensor driver 2000 waits for the first input 2000 and the second input 3000. The second operation mode DMD2 may be a mode in which the sensor driver 2000 senses the first input 2000 and waits for the second input 3000. The third operation mode DMD3 may be a mode in which the sensor driver 2000 senses the second input 3000.

According to some embodiments of the present disclosure, the sensor driver 2000 may first be driven in the first operation mode DMD1. When the first input 2000 is sensed in the first operation mode DMD1, the sensor driver 2000 may be switched (or, changed) to the second operation mode DMD2. Alternatively, when the second input 3000 is sensed in the first operation mode DMD1, the sensor driver 2000 may be switched (or, changed) to the third operation mode DMD3.

According to some embodiments of the present disclosure, when the second input 3000 is sensed in the second operation mode DMD2, the sensor driver 2000 may be switched to the third operation mode DMD3. When the first input 2000 is released (or, not sensed) in the second operation mode DMD2, the sensor driver 2000 may be switched to the first operation mode DMD1. When the second input 3000 is released (or, not sensed) in the third operation mode DMD3, the sensor driver 2000 may be switched to the first operation mode DMD1.

FIG. 11B is a view illustrating an operation of the sensor driver 2000 according to some embodiments of the present disclosure.

Referring to FIGS. 5, 11A, and 11B, operations in the first to third operation modes DMD1, DMD2, and DMD3 are illustrated in order of time (t).

In the first operation mode DMD1, the sensor driver 2000 may be repeatedly driven in a second mode MD2-d and a first mode MD1-d. During the second mode MD2-d, the sensor layer 200 may be scan-driven to detect the second input 3000. During the first mode MD1-d, the sensor layer 200 may be scan-driven to detect the first input 2000. Although FIG. 11B illustrates an example that the sensor driver 2000 operates in the first mode MD1-d continuously after the second mode MD2-d, the sequence is not limited thereto.

In the second operation mode DMD2, the sensor driver 2000 may be repeatedly driven in a second mode MD2-d and a first mode MD1. During the second mode MD2-d, the sensor layer 200 may be scan-driven to detect the second input 3000. During the first mode MD1, the sensor layer 200 may be scan-driven to detect the coordinates by the first input 2000.

In the third operation mode DMD3, the sensor driver 2000 may be driven in a second mode MD2. During the second mode MD2, the sensor layer 200 may be scan-driven to detect the coordinates by the second input 3000. In the third operation mode DMD3, the sensor driver 2000 may not operate in the first mode MD1-D or MD1 until the second input 3000 is released (or, not sensed).

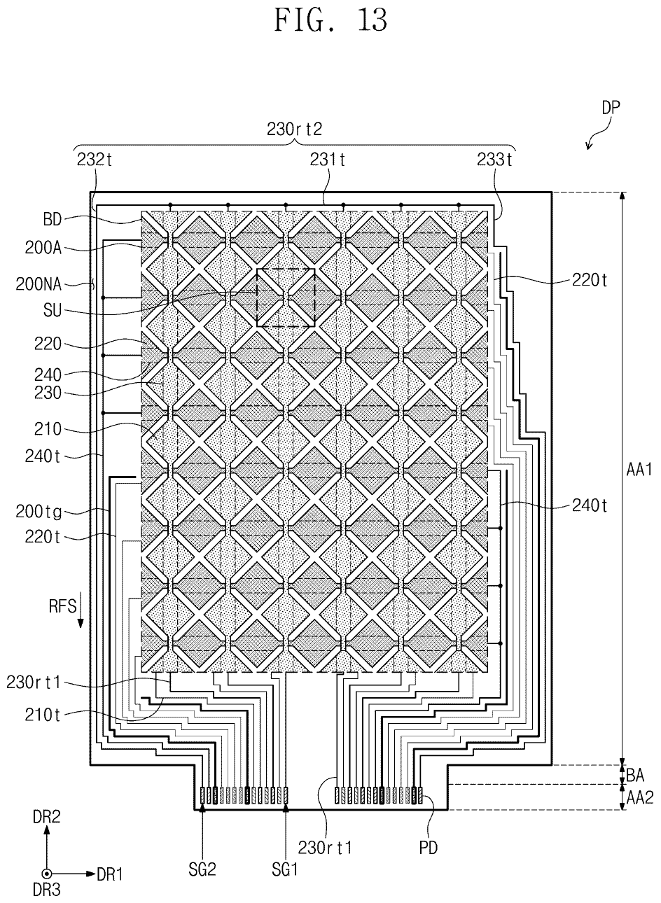

FIG. 12 is a view for explaining the first mode according to some embodiments of the present disclosure.

Referring to FIGS. 5, 11B, and 12, the first mode MD1-d of the first operation mode DMD1 and the first mode MD1 of the second operation mode DMD2 may include a mutual-capacitance detection mode. FIG. 12 is a view for explaining the mutual-capacitance detection mode in the first mode MD1-d of the first operation mode DMD1 and the first mode MD1 of the second operation mode DMD2.

In the mutual-capacitance detection mode, the sensor driver 2000 may sequentially provide a transmission signal TX to the first electrodes 210 and may detect the coordinates for the first input 2000 using a reception signal RX detected through the second electrodes 220. For example, the sensor driver 2000 may sense a change in the mutual capacitance between the first electrodes 210 and the second electrodes 220 and may calculate input coordinates.

FIG. 12 illustrates an example that the transmission signal TX is provided to one first electrode 210 and the reception signal RX is output from the second electrodes 220. The sensor driver 2000 may sense a change in the capacitance between the first electrode 210 and each of the second electrodes 220 and may detect the input coordinates for the first input 2000.

In the first mode MD1-d of the first operation mode DMD1 and the first mode MD1 of the second operation mode DMD2, the third electrodes 230, the fourth electrodes 240, and the guard lines 200tg may all be grounded. Accordingly, touch noise introduced through the third electrodes 230 and the fourth electrodes 240 may be prevented or reduced.

According to some embodiments of the present disclosure, at least one of the first mode MD1-d of the first operation mode DMD1 or the first mode MD1 of the second operation mode DMD2 may further include a self-capacitance detection mode. In the self-capacitance detection mode, the sensor driver 2000 may calculate input coordinates by outputting driving signals to the first electrodes 210 and the second electrodes 220 and sensing a change in the capacitance of each of the first electrodes 210 and the second electrodes 220.

In the self-capacitance detection mode, the third electrodes 230 and the fourth electrodes 240 may be grounded, and a signal the same as the signal provided to adjacent trace lines may be provided to the guard lines 200tg. Accordingly, parasitic capacitance formed between the trace lines may be relatively reduced or removed by the guard lines 200tg.

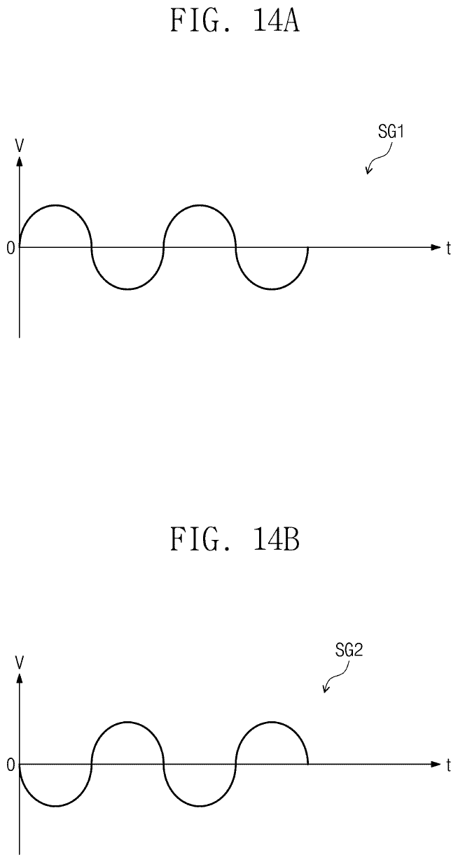

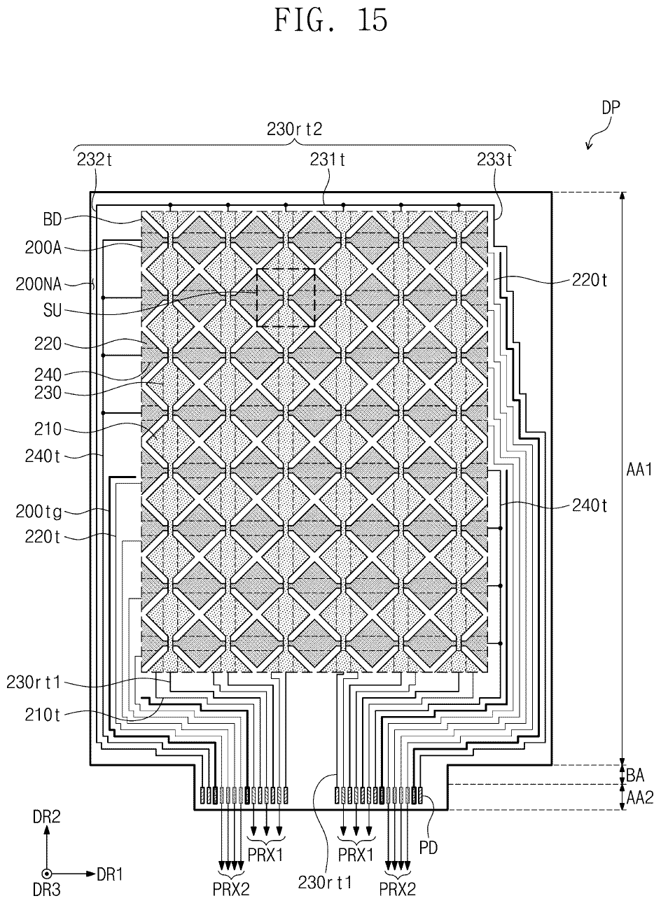

FIG. 13 is a view for explaining the second mode according to some embodiments of the present disclosure. FIG. 14A is a graph depicting the waveform of a first signal SG1 according to some embodiments of the present disclosure. FIG. 14B is a graph depicting the waveform of a second signal SG2 according to some embodiments of the present disclosure.

Referring to FIGS. 13, 14A, and 14B, the second mode MD2 may include a charging driving mode. The charging driving mode may include a searching charging driving mode and a tracking charging driving mode.

The searching charging driving mode may be a driving mode before the position of the pen PN is sensed. Accordingly, the first signal SG1 or the second signal SG2 may be sequentially provided to all channels included in the sensor layer 200. That is, in the searching charging driving mode, the entire area of the sensor layer 200 may be scanned. When the pen PN (refer to FIG. 5) is sensed in the searching charging driving mode, the sensor layer 200 may be driven in the tracking charging driving mode. For example, in the tracking charging driving mode, the sensor driver 2000 may sequentially output the first signal SG1 and the second signal SG2 to an area overlapping the point where the pen PN is sensed, rather than the entire sensor layer 200.

In the charging driving mode, the sensor driver 2000 may apply the first signal SG1 to one pad and may apply the second signal SG2 to another pad. The second signal SG2 may be an inverse signal of the first signal SG1. For example, the first signal SG1 may be a sinusoidal signal.

Because the first signal SG1 and the second signal SG2 are applied to at least two pads, a current RFS may have a current path to flow through one pad to another pad. In addition, because the first signal SG1 and the second signal SG2 are sinusoidal signals having an inverse phase relationship, the direction of the current RFS may be periodically varied. According to some embodiments of the present disclosure, the first signal SG1 and the second signal SG2 may be square-wave signals having an inverse phase relationship.

When the first signal SG1 and the second signal SG2 have an inverse phase relationship, noise caused in the display layer 100 (refer to FIG. 4) by the first signal SG1 may be cancelled out by noise caused by the second signal SG2. Accordingly, a flicker phenomenon may not occur in the display layer 100, and the display quality of the display layer 100 may be relatively improved.

According to some embodiments of the present disclosure, the first signal SG1 may be a sinusoidal signal. However, without being limited thereto, the first signal SG1 may be a square-wave signal. The second signal SG2 may have a certain constant voltage. For example, the second signal SG2 may be a ground voltage. That is, a pad to which the second signal SG2 is applied may be regarded as being grounded. Even in this case, the current RFS may flow from one pad to another pad. In addition, even though the other pad is grounded, the direction of the current RFS may be periodically varied because the first signal SG1 is a sinusoidal signal or a square-wave signal.

Referring to FIG. 13, the first signal SG1 is provided to one pad connected with one first auxiliary trace line 230rt1, and the second signal SG2 is provided to one pad connected with the second auxiliary trace line 230rt2. The current RFS may flow along the current path defined by the one first auxiliary trace line 230rt1, one third electrode 230 connected to the one first auxiliary trace line 230rt1, and a portion of the second auxiliary trace line 230rt2. The current path may have a coil shape. Accordingly, in the charging driving mode of the second mode, the resonance circuit of the pen PN may be charged by a magnetic field formed by the current path.

According to some embodiments of the present disclosure, a signal may not be applied to pads to which the first signal SG1 and the second signal SG2 are not applied, among the pads connected to the first auxiliary trace lines 230rt1 and the two pads connected to the second auxiliary trace line 230rt2. That is, first ends of third electrodes 230 that do not receive the first signal SG1 or the second signal SG2 among the third electrodes 230 may be expressed as being floated. The expression “first ends are floated” may mean that a signal is not applied to the pads PD connected with the first ends of the third electrodes 230.

According to the present disclosure, a current path having a loop coil pattern may be implemented by components included in the sensor layer 200. Accordingly, the electronic device 1000 (refer to FIG. 1A) may charge the pen PN using the sensor layer 200. Thus, a component having a coil for charging the pen PN does not need to be separately added so that an increase in the thickness and weight of the electronic device 1000 and a decrease in the flexibility of the electronic device 1000 may not occur.

In the charging driving mode, the first electrodes 210, the second electrodes 220, the fourth electrodes 240, and the guard lines 200tg may be grounded or electrically floated, or may receive a constant voltage. In particular, the first electrodes 210, the second electrodes 220, the fourth electrodes 240, and the guard lines 200tg may be floated. That is, a signal may not be provided to the pads PD that are connected to the first electrodes 210, the second electrodes 220, the fourth electrodes 240, and the guard lines 200tg. In this case, the current RFS may not flow to the first electrodes 210, the second electrodes 220, the fourth electrodes 240, and the guard lines 200tg.

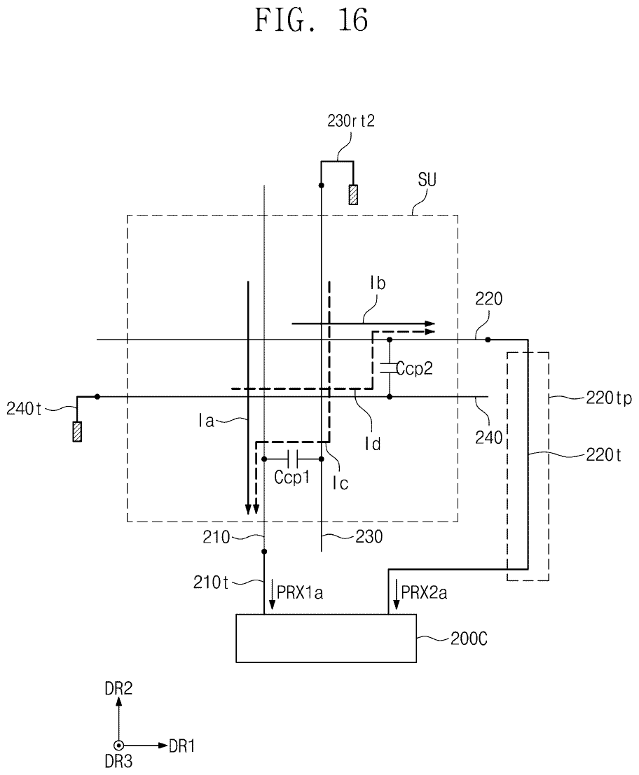

FIG. 15 is a view for explaining the second mode according to some embodiments of the present disclosure. FIG. 16 is a view for explaining the second mode based on a sensing unit according to some embodiments of the present disclosure.

Referring to FIGS. 15 and 16, the second mode may include a charging driving mode and a pen sensing driving mode. FIGS. 15 and 16 are views for explaining the pen sensing driving mode. Referring to FIG. 15, in the pen sensing driving mode, first reception signals PRX1 may be output from the first electrodes 210, and second reception signals PRX2 may be output from the second electrodes 220. In FIG. 16, one sensing unit SU through which first to fourth induced currents Ia, Ib, Ic, and Id generated by the pen PN (refer to FIG. 5) flow is illustrated.

According to some embodiments of the present disclosure, the routing directions of one electrode and another electrode of the sensor layer 200 that overlap each other may be different from each other. For example, the routing direction of the first electrode 210 and the routing direction of the third electrode 230 may be different from each other. In addition, the routing direction of the second electrode 220 and the routing direction of the fourth electrode 240 may be different from each other. For example, in FIG. 16, the first electrode 210 and the first trace line 210t may be connected on the lower side of the sensing unit SU, and the third electrode 230 and the second auxiliary trace line 230rt2 may be connected on the upper side of the sensing unit SU. The second electrode 220 and the second trace line 220t may be connected on the right side of the sensing unit SU, and the fourth electrode 240 and the auxiliary trace line 240t may be connected on the left side of the sensing unit SU.

The RLC resonance circuit of the pen PN may emit a magnetic field having a resonant frequency while discharging charged charges. Due to the magnetic field provided by the pen PN, the first induced current Ia may be generated in the first electrode 210, and the second induced current Ib may be generated in the second electrode 220. In addition, the third induced current Ic may be generated in the third electrode 230, and the fourth induced current Id may be generated in the fourth electrode 240.

A first coupling capacitance Ccp1 may be formed between the third electrode 230 and the first electrode 210, and a second coupling capacitance Ccp2 may be formed between the fourth electrode 240 and the second electrode 220. The third induced current Ic may be transferred to the first electrode 210 through the first coupling capacitor Ccp1, and the fourth induced current Id may be transferred to the second electrode 220 through the second coupling capacitor Ccp2.

The sensor driver 200c may receive a first reception signal PRX1a based on the first induced current Ia and the third induced current Ic from the first electrode 210 and may receive a second reception signal PRX2a based on the second induced current Ib and the fourth induced current Id from the second electrode 220. The sensor driver 2000 may detect the input coordinates of the pen PN, based on the first reception signal PRX1a and the second reception signal PRX2a.

The extension direction of a portion 220tp of the second trace line 220t may be the same as the arrangement direction of the second electrodes 220. That is, the portion 220tp of the second trace line 220t may extend in the second direction DR2. In this case, in a process of calculating a coordinate with respect to an axis parallel to the second direction DR2, a current induced in the portion 220tp of the second trace line 220t may cause noise in the calculation of the coordinate. Accordingly, to remove an influence of the second trace lines 220t, the sensor driver 2000 may perform an operation of differentially sensing signals received from the second electrodes 220.

When the sensor driver 2000 receives the first reception signal PRX1a from the first electrode 210 and receives the second reception signal PRX2a from the second electrode 220, first ends of the third electrode 230 and the fourth electrode 240 may all be floated. Accordingly, compensation of a sensing signal may be maximized by the coupling between the first electrode 210 and the third electrode 230 and the coupling between the second electrode 220 and the fourth electrode 240.

In addition, second ends of the third electrode 230 and the fourth electrode 240 may be grounded or floated. Accordingly, the third induced current Ic and the fourth induced current Id may be sufficiently transferred to the first electrode 210 and the second electrode 220 by the coupling between the first electrode 210 and the third electrode 230 and the coupling between the second electrode 220 and the fourth electrode 240. When the first and second ends of the third electrode 230 and the fourth electrode 240 are all floated, the potential may not rapidly change during the pen sensing operation even though charges are charged to the third electrode 230 in the charging driving mode. Accordingly, noise caused by a change in the driving mode may be minimized.

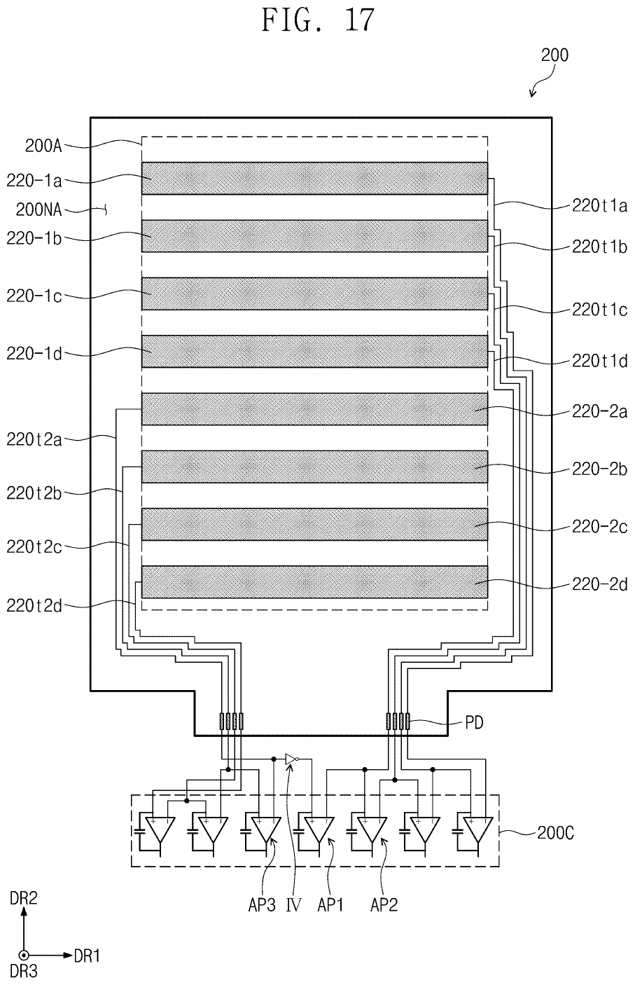

FIG. 17 is a view illustrating some components of the sensor layer 200 and some components of the sensor driver 2000 according to some embodiments of the present disclosure.

Referring to FIGS. 7A, 16, and 17, the second electrodes 220 of the sensor layer 200 may include second electrodes 220-1a, 220-1b, 220-1c, 220-1d, 220-2a, 220-2b, 220-2c, and 220-2d sequentially arranged in the second direction DR2. The second trace lines 220t of the sensor layer 200 may include second trace lines 220t1a, 220t1b, 220t1c, 220t1d, 220t2a, 220t2b, 220t2c, and 220t2d electrically connected with the second electrodes 220-1a, 220-1b, 220-1c, 220-1d, 220-2a, 220-2b, 220-2c, and 220-2d in a one-to-one correspondence.

The second trace lines 220t1a, 220t1b, 220t1c, 220t1d, 220t2a, 220t2b, 220t2c, and 220t2d may be divided into second-first trace lines 220t1a, 220t1b, 220t1c, and 220t1d and second-second trace lines 220t2a, 220t2b, 220t2c, and 220t2d spaced apart from each other with the sensing area 200A therebetween.

In the pen sensing driving mode for sensing a pen input, the sensor driver 2000 may calculate a coordinate with respect to an axis parallel to the first direction DR1 based on a signal received from the first electrodes 210 and may calculate a coordinate with respect to an axis parallel to the second direction DR2 based on a signal received from the second electrodes 220.

Referring to FIG. 16 together, the extension direction of the portion 220tp of the second trace line 220t may be the same as the arrangement direction of the second electrodes 220. That is, the portion 220tp of the second trace line 220t may extend in the second direction DR2. In this case, in the process of calculating the coordinate with respect to the axis parallel to the second direction DR2, a current induced in the portion 220tp of the second trace line 220t may cause noise in the calculation of the coordinate.

According to some embodiments of the present disclosure, the sensor driver 2000 may differentially sense signals received from two different second electrodes among the second electrodes 220-1a, 220-1b, 220-1c, 220-1d, 220-2a, 220-2b, 220-2c, and 220-2d. In this case, an influence of the second trace lines 220t1a, 220t1b, 220t1c, 220t1d, 220t2a, 220t2b, 220t2c, and 220t2d may be removed so that noise affecting coordinate distortion may be reduced or removed. Thus, the accuracy (e.g., linearity) of coordinates sensed by the sensor layer 200 and the sensor driver 2000 may be relatively improved.

The sensor driver 2000 may include a plurality of amplifiers AP1, AP2, and AP3 and an inverter IV. The amplifiers AP1, AP2, and AP3 may include the first amplifier AP1, the second amplifier AP2, and the third amplifier AP3. The first amplifier AP1 may include a first input terminal that is an inverting input terminal and a second input terminal that is a non-inverting input terminal. The second amplifier AP2 may include a third input terminal that is an inverting input terminal and a fourth input terminal that is a non-inverting input terminal. The third amplifier AP3 may include a fifth input terminal that is an inverting input terminal and a sixth input terminal that is a non-inverting input terminal.

The first input terminal of the first amplifier AP1 may be electrically connected with the second-first electrode 220-1d, and the second input terminal of the first amplifier AP1 may be electrically connected with the second-second electrode 220-2a via the inverter IV. Among the second-first trace lines 220t1a, 220t1b, 220t1c, and 220t1d, the second-first trace line 220t1d may be electrically connected to the second-first electrode 220-1d and the first input terminal of the first amplifier AP1. Among the second-second trace lines 220t2a, 220t2b, 220t2c, and 220t2d, the second-second trace line 220t2a may be electrically connected to the second-second electrode 220-2a and the inverter IV.

In the pen sensing driving mode, the first input terminal of the first amplifier AP1 may receive a signal based on an induced current induced in the second-first electrode 220-1d and an induced current induced in the second-first trace line 220t1d, and the second input terminal of the first amplifier AP1 may receive a signal based on an induced current induced in the second-second electrode 220-2a and an induced current induced in the second-second trace line 220t2a.

The second-first trace line 220t1d and the second-second trace line 220t2a are spaced apart from each other with the sensing area 200A therebetween. Accordingly, the direction of the current induced in the second-first trace line 220t1d may be opposite to the direction of the current induced in the second-second trace line 220t2a. The sensor driver 2000 may perform differential sensing by inverting a signal of one of the second-first trace line 220t1d and the second-second trace line 220t2a using the inverter IV. Thus, the current induced in the second-first trace line 220t1d and the current induced in the second-second trace line 220t2a, which are induced in different directions, may cancel each other out so that noise affecting coordinate distortion may be reduced or removed.

According to some embodiments of the present disclosure, even though the routing directions of the second electrodes 220 are different from each other, noise affecting coordinate distortion may be removed using the inverter IV. Accordingly, the degree of freedom in the design of the routing directions of the second electrodes 220 may be relatively improved, and design for reducing the area of the peripheral area 200NA may be made easier.

The third input terminal and the fourth input terminal of the second amplifier AP2 may be electrically connected to corresponding second-first trace lines among the second-first trace lines 220t1a, 220t1b, 220t1c, and 220t1d, respectively. The fifth input terminal and the sixth input terminal of the third amplifier AP3 may be electrically connected to corresponding second-second trace lines among the second-second trace lines 220t2a, 220t2b, 220t2c, and 220t2d, respectively.

According to some embodiments of the present disclosure, the sensor driver 2000 may differentially sense signals received from two second electrodes located closest to each other among the second electrodes 220. In this case, among the second electrodes 220, the second-first electrode 220-1d and the second-second electrode 220-2a may be located adjacent to each other, and some of the remaining second electrodes and the other remaining second electrodes may be spaced apart from each other with the second-first electrode 220-1d and the second-second electrode 220-2a therebetween.

The second-first electrode 220-1d may be electrically connected with the fourth input terminal of the second amplifier AP2, and the second-second electrode 220-2a may be electrically connected with the fifth input terminal of the third amplifier AP3. In the pen sensing driving mode, the first amplifier AP1 may receive a first reception signal based on the induced current flowing through the second-first electrode 220-1d and a second reception signal based on the induced current flowing through the second-second electrode 220-2a. The current induced in the second-first trace line 220t1d may be further included in the first reception signal, and the current induced in the second-second trace line 220t2a may be further included in the second reception signal.

A signal output from the first amplifier AP1 may be a signal in which a signal by the current induced in the second-first trace line 220t1d and a signal by the current induced in the second-second trace line 220t2a cancel each other out. That is, the sensor driver 2000 may differentially sense signals received from the second electrodes 220 in the second mode and may calculate a coordinate with respect to an axis parallel to the second direction DR2 based on a signal in which signals caused by the second trace lines 220t cancel each other out. Thus, the accuracy (e.g., linearity) of coordinates sensed by the sensor layer 200 and the sensor driver 2000 may be relatively improved.

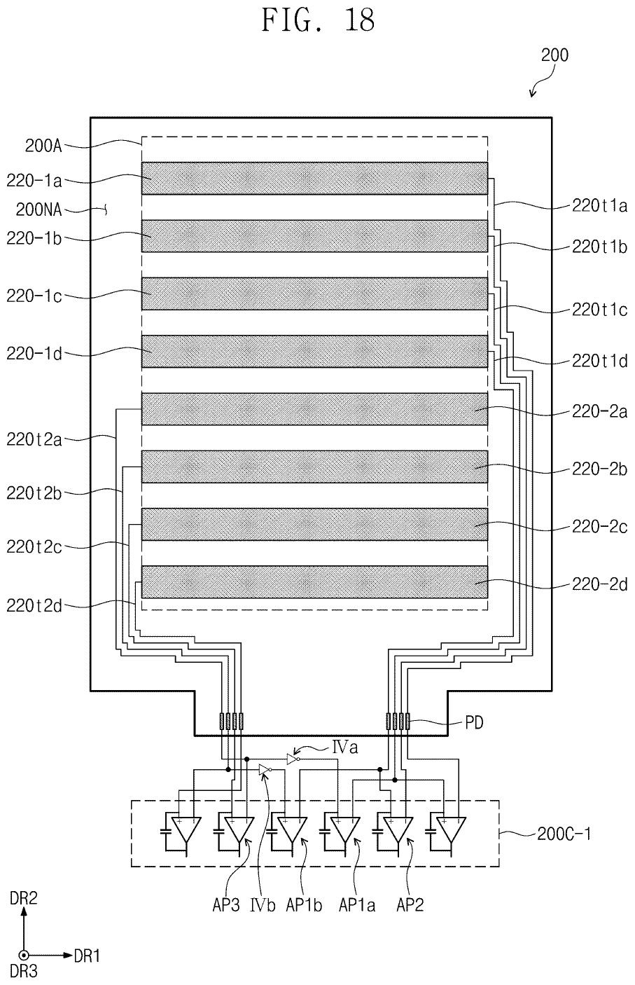

FIG. 18 is a view illustrating some components of the sensor layer 200 and some components of a sensor driver 200C-1 according to some embodiments of the present disclosure. In describing FIG. 18, the components described with reference to FIG. 17 will be assigned with the identical reference numerals, and descriptions thereabout will be omitted.

Referring to FIG. 18, the sensor driver 200C-1 may include a plurality of amplifiers AP1a, AP1b, AP2, and AP3, a first inverter IVa, and a second inverter IVb. The plurality of amplifiers AP1a, AP1b, AP2, and AP3 may include the first-first amplifier AP1a, the first-second amplifier AP1b, the second amplifier AP2, and the third amplifier AP3.

According to some embodiments of the present disclosure, the sensor driver 200C-1 may differentially sense two second electrodes spaced apart from each other with at least one other second electrode therebetween among the second electrodes 220-1a, 220-1b, 220-1c, 220-1d, 220-2a, 220-2b, 220-2c, and 220-2d. In this case, the cancellation of effective induced currents induced in the two second electrodes may be minimized, and non-effective induced currents induced in second trace lines connected to the two second electrodes may cancel each other out. Accordingly, an influence of the second trace lines 220t1a, 220t1b, 220t1c, 220t1d, 220t2a, 220t2b, 220t2c, and 220t2d may be removed so that noise affecting coordinate distortion may be reduced or removed. Thus, the accuracy (e.g., linearity) of coordinates sensed by the sensor layer 200 and the sensor driver 200C-1 may be relatively improved.

Although FIG. 18 illustrates an example that one second electrode is located between the two second electrodes differentially sensed, embodiments according to the present disclosure are not particularly limited thereto. For example, two or more second electrodes may be located between the two second electrodes differentially sensed.

According to some embodiments of the present disclosure, an inverting terminal of the first-first amplifier AP1a may be electrically connected with the second electrode 220-1c, and a non-inverting terminal of the first-first amplifier AP1a may be electrically connected with the second electrode 220-2a through the first inverter IVa. The second electrode 220-1d may be located between the second electrode 220-1c and the second electrode 220-2a.

An inverting terminal of the first-second amplifier AP1b may be electrically connected with the second electrode 220-1d, and a non-inverting terminal of the first-second amplifier AP1b may be electrically connected with the second electrode 220-2b through the second inverter IVb. An inverting terminal of the second amplifier AP2 may be electrically connected with the second electrode 220-1b, and a non-inverting terminal of the second amplifier AP2 may be electrically connected with the second electrode 220-1d. An inverting terminal of the third amplifier AP3 may be electrically connected with the second electrode 220-2a, and a non-inverting terminal of the third amplifier AP3 may be electrically connected with the second electrode 220-2c.

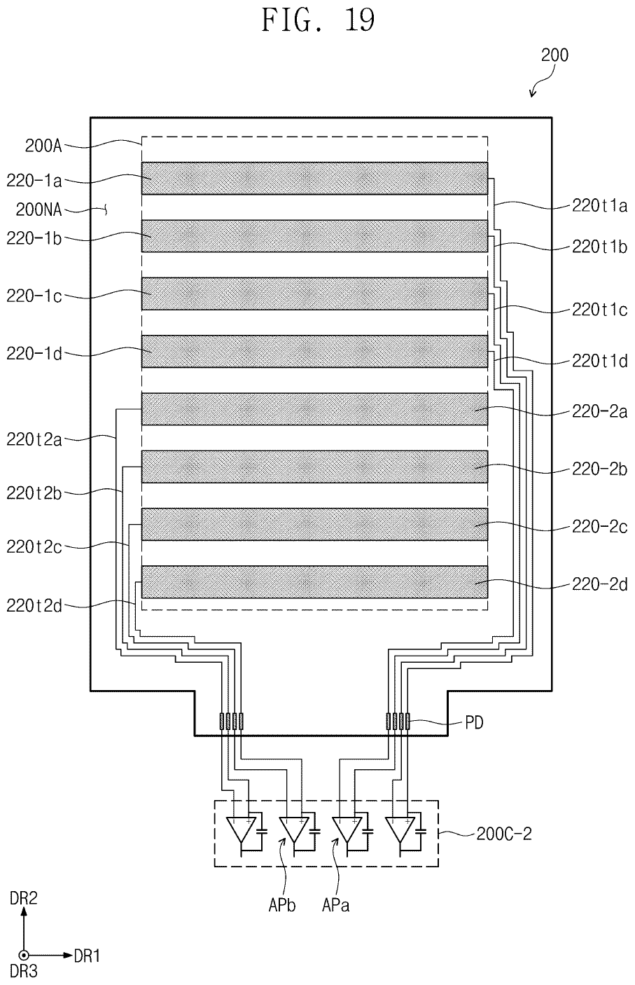

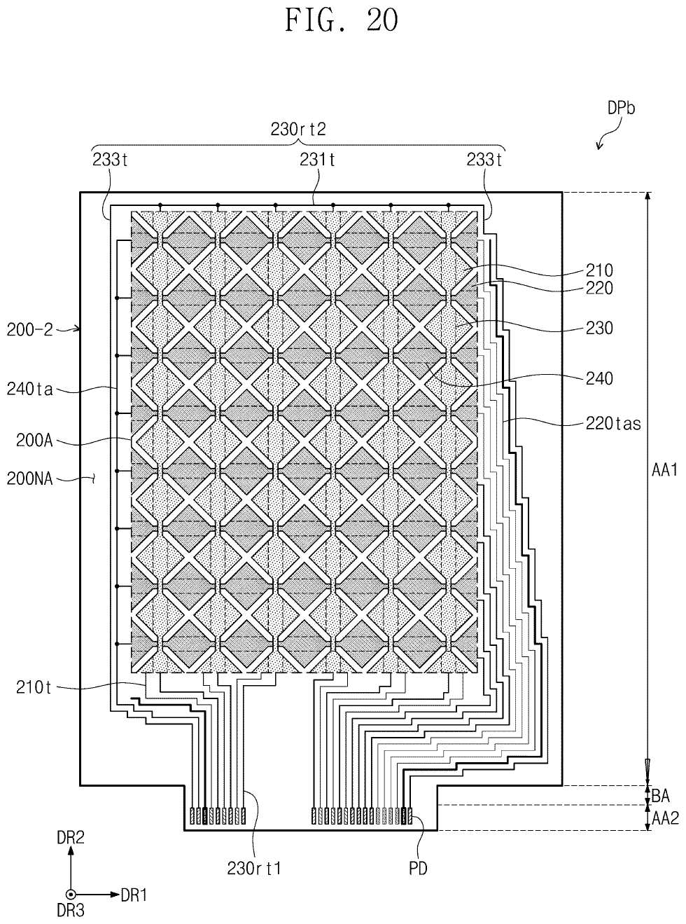

FIG. 19 is a view illustrating some components of the sensor layer 200 and some components of a sensor driver 200C-2 according to some embodiments of the present disclosure. In describing FIG. 19, the components described with reference to FIG. 17 will be assigned with the identical reference numerals, and descriptions thereabout will be omitted.

Referring to FIG. 19, the sensor driver 200C-2 may include a plurality of amplifiers APa and APb. The plurality of amplifiers APa and APb may include the first amplifier APa and the second amplifier APb.

According to some embodiments of the present disclosure, the sensor driver 200C-2 may differentially sense two second electrodes routed in the same direction among the second electrodes 220-1a, 220-1b, 220-1c, 220-1d, 220-2a, 220-2b, 220-2c, and 220-2d. In this case, an influence of the second trace lines 220t1a, 220t1b, 220t1c, 220t1d, 220t2a, 220t2b, 220t2c, and 220t2d may be removed so that noise affecting coordinate distortion may be reduced or removed. Thus, the accuracy (e.g., linearity) of coordinates sensed by the sensor layer 200 and the sensor driver 200C-2 may be relatively improved.

FIG. 20 is a plan view of a display panel DPb according to some embodiments of the present disclosure. In describing FIG. 20, components identical to the components described with reference to FIG. 7A will be assigned with the identical reference numerals, and descriptions thereabout will be omitted.

Referring to FIG. 20, the display panel DPb includes a sensor layer 200-2. The sensor layer 200-2 may include a plurality of first electrodes 210, a plurality of second electrodes 220, a plurality of third electrodes 230, and a plurality of fourth electrodes 240 located in a sensing area 200A.

The sensor layer 200-2 may further include a plurality of first trace lines 210t, a plurality of second trace lines 220tas, a plurality of first auxiliary trace lines 230rt1, a second auxiliary trace line 230rt2, and an auxiliary trace line 240ta located in a peripheral area 200NA.

According to some embodiments of the present disclosure, the second trace lines 220tas may be electrically connected to the second electrodes 220 in a one-to-one correspondence. The auxiliary trace line 240ta may be electrically connected with all of the fourth electrodes 240. According to some embodiments of the present disclosure, the second trace lines 220tas and the auxiliary trace line 240ta may be spaced apart from each other with the sensing area 200A therebetween.

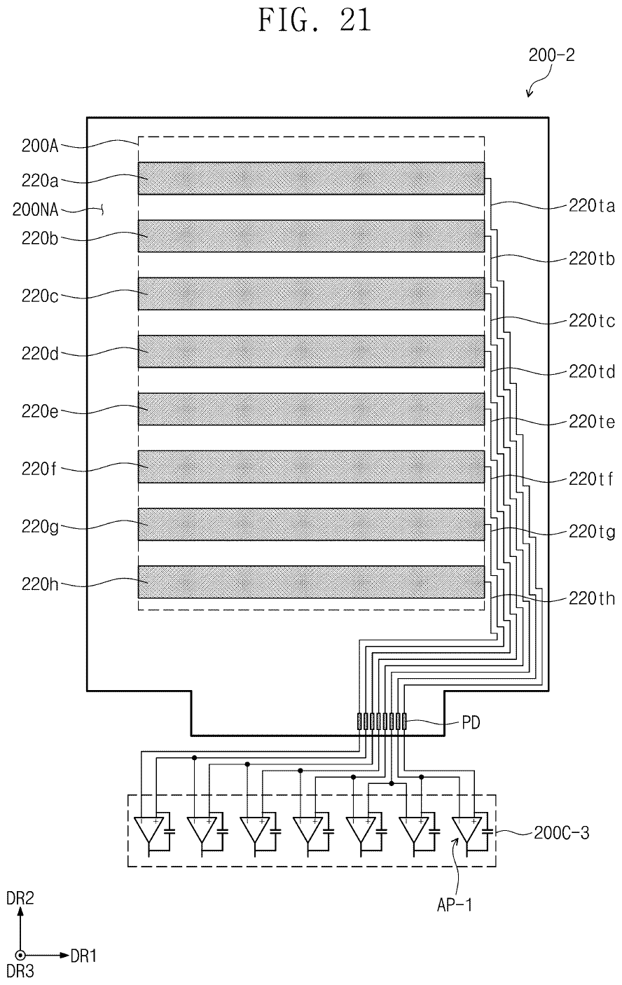

FIG. 21 is a view illustrating some components of the sensor layer 200-2 and some components of a sensor driver 200C-3 according to some embodiments of the present disclosure.

Referring to FIGS. 20 and 21, the second electrodes 220 of the sensor layer 200-2 may include second electrodes 220a, 220b, 220c, 220d, 220e, 220f, 220g, and 220h sequentially arranged in the second direction DR2. The second trace lines 220tas of the sensor layer 200-2 may include second trace lines 220ta, 220tb, 220tc, 220td, 220te, 220tf, 220tg, and 220th electrically connected with the second electrodes 220a, 220b, 220c, 220d, 220e, 220f, 220g, and 220h in a one-to-one correspondence.

The sensor driver 200C-3 may include a plurality of amplifiers AP-1. Each of the amplifiers AP-1 may differentially sense signals received from two different adjacent second electrodes among the second electrodes 220a, 220b, 220c, 220d, 220e, 220f, 220g, and 220h. In this case, an influence of the second trace lines 220ta, 220tb, 220tc, 220td, 220te, 220tf, 220tg, and 220th may be removed so that noise affecting coordinate distortion may be reduced or removed. Thus, the accuracy (e.g., linearity) of coordinates sensed by the sensor layer 200-2 and the sensor driver 2000-3 may be relatively improved.

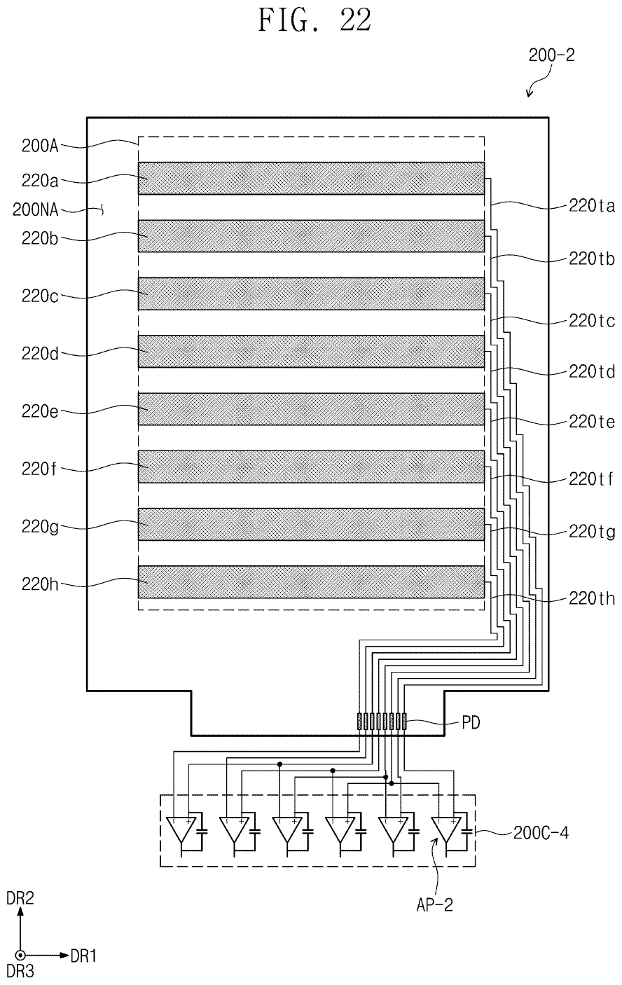

FIG. 22 is a view illustrating some components of the sensor layer 200-2 and some components of a sensor driver 200C-4 according to some embodiments of the present disclosure. In describing FIG. 22, the components described with reference to FIG. 21 will be assigned with the identical reference numerals, and descriptions thereabout will be omitted.

Referring to FIG. 22, the sensor driver 200C-4 may include a plurality of amplifiers AP-2. Each of the amplifiers AP-2 may differentially sense signals received from two different second electrodes spaced apart from each other with at least one second electrode therebetween among the second electrodes 220a, 220b, 220c, 220d, 220e, 220f, 220g, and 220h. In this case, the cancellation of effective induced currents induced in the two different second electrodes may be minimized, and non-effective induced currents induced in second trace lines connected to the two different second electrodes may cancel each other out. In this case, an influence of the second trace lines 220ta, 220tb, 220tc, 220td, 220te, 220tf, 220tg, and 220th may be removed so that noise affecting coordinate distortion may be reduced or removed. Thus, the accuracy (e.g., linearity) of coordinates sensed by the sensor layer 200-2 and the sensor driver 200C-4 may be relatively improved.

Although FIG. 22 illustrates an example that one second electrode is located between the two different second electrodes differentially sensed, embodiments according to the present disclosure are not particularly limited thereto. For example, two or more second electrodes may be located between the two different second electrodes differentially sensed.

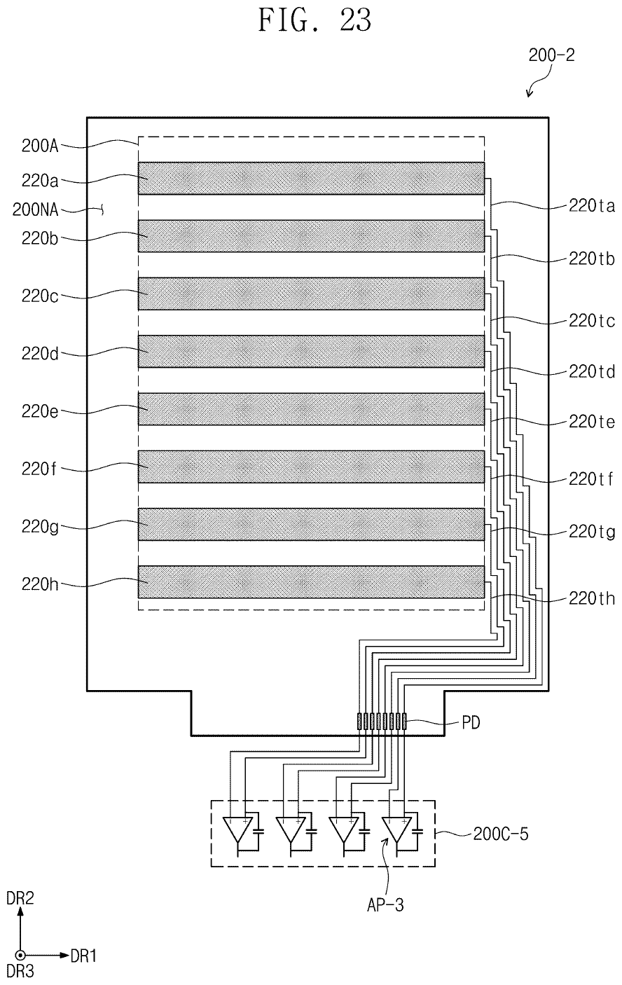

FIG. 23 is a view illustrating some components of the sensor layer 200-2 and some components of a sensor driver 200C-5 according to some embodiments of the present disclosure. In describing FIG. 23, the components described with reference to FIG. 21 will be assigned with the identical reference numerals, and descriptions thereabout will be omitted.

Referring to FIG. 23, the sensor driver 200C-5 may include a plurality of amplifiers AP-3. Each of the amplifiers AP-3 may differentially sense signals received from two different adjacent second electrodes among the second electrodes 220a, 220b, 220c, 220d, 220e, 220f, 220g, and 220h. In this case, an influence of the second trace lines 220ta, 220tb, 220tc, 220td, 220te, 220tf, 220tg, and 220th may be removed so that noise affecting coordinate distortion may be reduced or removed. Thus, the accuracy (e.g., linearity) of coordinates sensed by the sensor layer 200-2 and the sensor driver 200C-5 may be relatively improved.

As described above, not only a touch input but also an input by a pen may be sensed through the sensor layer. Accordingly, a separate component (e.g., a digitizer) for sensing a pen does not need to be added to the electronic device, and thus an increase in the thickness and weight of the electronic device and a decrease in the flexibility of the electronic device depending on the addition of the digitizer may not occur. In addition, the sensor driver may differentially sense signals received from two different electrodes such that currents induced in trace lines cancel each other out. Thus, the accuracy (e.g., linearity) of coordinates sensed by the sensor layer and the sensor driver may be relatively improved.

While aspects of some embodiments of the present disclosure have been described with reference to some embodiments thereof, it will be apparent to those of ordinary skill in the art that various changes and modifications may be made thereto without departing from the spirit and scope of the present disclosure as set forth in the following claims, and their equivalents.

What is claimed is:

1. An electronic device comprising:
a sensor layer in which a sensing area and a peripheral area adjacent to the sensing area are defined; and
a sensor driver configured to drive the sensor layer, the sensor driver including a plurality of amplifiers and an inverter,
wherein the sensor layer includes:
a plurality of first electrodes in the sensing area and arranged in a first direction;
a plurality of second electrodes in the sensing area and arranged in a second direction crossing the first direction, the plurality of second electrodes being configured to cross the plurality of first electrodes;
a plurality of first trace lines electrically connected to the plurality of first electrodes in a one-to-one correspondence; and
a plurality of second trace lines electrically connected to the plurality of second electrodes in a one-to-one correspondence, and
wherein the plurality of amplifiers include a first amplifier including a first input terminal and a second input terminal, the first input terminal is electrically connected with a second-first electrode among the plurality of second electrodes, and the second input terminal is electrically connected with a second-second electrode among the plurality of second electrodes via the inverter.

2. The electronic device of claim 1, wherein the plurality of second trace lines include a plurality of second-first trace lines and a plurality of second-second trace lines spaced apart from each other with the sensing area therebetween.

3. The electronic device of claim 2, wherein one second-first trace line among the plurality of second-first trace lines is electrically connected to the second-first electrode and the first input terminal, and
wherein one second-second trace line among the plurality of second-second trace lines is electrically connected to the second-second electrode and the inverter.

4. The electronic device of claim 3, wherein the sensor driver is configured to selectively operate in a first mode to sense a touch input or in a second mode to sense a pen input,
wherein the second mode includes a pen sensing driving mode, and
wherein in the pen sensing driving mode, the first amplifier receives a first reception signal based on an induced current flowing through the second-first electrode and a second reception signal based on an induced current flowing through the second-second electrode.

5. The electronic device of claim 4, wherein a signal output from the first amplifier in the pen sensing driving mode is a signal in which signals by currents induced in the one second-first trace line and the one second-second trace line cancel each other out.

6. The electronic device of claim 2, wherein the plurality of amplifiers further include a second amplifier including a third input terminal and a fourth input terminal and a third amplifier including a fifth input terminal and a sixth input terminal,
wherein the third input terminal and the fourth input terminal are electrically connected to corresponding second-first trace lines among the plurality of second-first trace lines, respectively, and
wherein the fifth input terminal and the sixth input terminal are electrically connected to corresponding second-second trace lines among the plurality of second-second trace lines, respectively.

7. The electronic device of claim 6, wherein the second-first electrode is electrically connected with the fourth input terminal of the second amplifier.

8. The electronic device of claim 6, wherein the second-second electrode is electrically connected with the fifth input terminal of the third amplifier.

9. The electronic device of claim 6, wherein the first input terminal, the third input terminal, and the fifth input terminal are inverting input terminals, and
wherein the second input terminal, the fourth input terminal, and the sixth input terminal are non-inverting input terminals.

10. The electronic device of claim 1, further comprising:
a plurality of pads electrically connected to the plurality of first trace lines and the plurality of second trace lines,
wherein the plurality of pads are arranged in the first direction.

11. The electronic device of claim 1, wherein the plurality of second trace lines are longer than the plurality of first trace lines.

12. The electronic device of claim 1, wherein at least one second electrode among the plurality of second electrodes is between the second-first electrode and the second-second electrode.

13. The electronic device of claim 1, wherein the second-first electrode and the second-second electrode are adjacent to each other, and
wherein among the plurality of second electrodes, some of the remaining second electrodes and the other remaining second electrodes are spaced apart from each other with the second-first electrode and the second-second electrode therebetween.

14. An electronic device comprising:
a sensor layer in which a sensing area and a peripheral area adjacent to the sensing area are defined; and
a sensor driver configured to drive the sensor layer, wherein the sensor driver is configured to selectively operate in a first mode to sense a touch input or in a second mode to sense a pen input,
wherein the sensor layer includes:
a plurality of first electrodes in the sensing area and arranged in a first direction;
a plurality of second electrodes in the sensing area and arranged in a second direction crossing the first direction, the plurality of second electrodes being configured to cross the plurality of first electrodes;
a plurality of first trace lines electrically connected to the plurality of first electrodes in a one-to-one correspondence; and
a plurality of second trace lines electrically connected to the plurality of second electrodes in a one-to-one correspondence,
wherein portions of the plurality of second trace lines spaced apart from the sensing area in the first direction extend in the second direction, and
wherein in the second mode, the sensor driver is configured to differentially sense signals received from the plurality of second electrodes and to calculate a coordinate with respect to an axis parallel to the second direction based on a signal in which signals caused by the plurality of second trace lines cancel each other out.

15. The electronic device of claim 14, wherein the sensor driver includes a plurality of amplifiers and an inverter,
wherein the plurality of second trace lines include a plurality of second-first trace lines and a plurality of second-second trace lines spaced apart from each other with the sensing area therebetween,
wherein the plurality of amplifiers include a first amplifier including a first input terminal and a second input terminal, the first input terminal is electrically connected with a second-first electrode among the plurality of second electrodes, and the second input terminal is electrically connected with a second-second electrode among the plurality of second electrodes via the inverter,
wherein one second-first trace line among the plurality of second-first trace lines is electrically connected to the second-first electrode and the first input terminal, and
wherein one second-second trace line among the plurality of second-second trace lines is electrically connected to the second-second electrode and the inverter.

16. The electronic device of claim 15, wherein at least one second electrode among the plurality of second electrodes is between the second-first electrode and the second-second electrode.

17. The electronic device of claim 15, wherein the second-first electrode and the second-second electrode are adjacent to each other, and
wherein among the plurality of second electrodes, some of the remaining second electrodes and the other remaining second electrodes are spaced apart from each other with the second-first electrode and the second-second electrode therebetween.

18. The electronic device of claim 15, wherein the plurality of amplifiers further include a second amplifier including a third input terminal and a fourth input terminal and a third amplifier including a fifth input terminal and a sixth input terminal,
wherein the third input terminal and the fourth input terminal are electrically connected to corresponding second-first trace lines among the plurality of second-first trace lines, respectively, and
wherein the fifth input terminal and the sixth input terminal are electrically connected to corresponding second-second trace lines among the plurality of second-second trace lines, respectively.

19. An electronic device comprising:
a sensor layer in which a sensing area and a peripheral area adjacent to the sensing area are defined; and
a sensor driver configured to drive the sensor layer, wherein the sensor driver is configured to selectively operate in a first mode to sense a touch input or in a second mode to sense a pen input,
wherein the sensor layer includes:
a plurality of first electrodes in the sensing area and arranged in a first direction;
a plurality of second electrodes in the sensing area and arranged in a second direction crossing the first direction, the plurality of second electrodes being configured to cross the plurality of first electrodes;
a plurality of first trace lines electrically connected to the plurality of first electrodes in a one-to-one correspondence; and
a plurality of second trace lines electrically connected to the plurality of second electrodes in a one-to-one correspondence,
wherein the plurality of second trace lines include a plurality of second-first trace lines and a plurality of second-second trace lines spaced apart from each other with the sensing area therebetween, and
wherein in the second mode, the sensor driver is configured to calculate a coordinate by differentially sensing signals received from one second-first trace line among the plurality of second-first trace lines and one second-second trace line among the plurality of second-second trace lines.

20. The electronic device of claim 19, wherein the sensor driver includes an amplifier including a first input terminal and a second input terminal and an inverter electrically connected to the second input terminal of the amplifier,
wherein the one second-first trace line is electrically connected to the first input terminal, and
wherein the one second-second trace line is electrically connected to the second input terminal via the inverter.

21. The electronic device of claim 20, wherein the second mode includes a pen sensing driving mode,
wherein in the pen sensing driving mode, the amplifier receives a first reception signal based on an induced current flowing through a second-first electrode connected to the one second-first trace line among the plurality of second electrodes and a second reception signal based on an induced current flowing through a second-second electrode connected to the one second-second trace line among the plurality of second electrodes, and
wherein a signal output from the amplifier is a signal in which signals by currents induced in the one second-first trace line and the one second-second trace line cancel each other out.

22. The electronic device of claim 19, wherein the electronic device is one of a television, a mobile phone, a tablet computer, a notebook computer, a car navigation, or a game machine.
